(19) United States
(12) Patent Application Publication
(10) Pub. No.: US 2026/0101246 A1
(43) Pub. Date: Apr. 9, 2026

(54) Time Alignment for Inter-Cell Mobility

(71) Applicant: Telefonaktiebolaget LM Ericsson (publ), Stockholm (SE)

(72) Inventors: Icaro Leonardo Da Silva, SOLNA (SE); Claes Tidestav, BÅLSTA (SE); Asbjörn Grövlen, Stockholm (SE); Venkatarao Gonuguntla, Sundbyberg (SE); Antonino Orsino, KIRKKONUMMI (FI); Stefan Wager, Espoo (FI)

(21) Appl. No.: 19/115,877

(22) PCT Filed: Sep. 29, 2023
(86) PCT No.: PCT/SE2023/050966

§ 371 Date: Mar. 27, 2025

Related U.S. Application Data
(60) Provisional application No. 63/412,060, filed on Sep. 30, 2022.

(51) Int. Cl. H04W 36/00; H04W 36/08

(52) U.S. Cl. CPC H04W 36/0072; H04W 36/08

(57) ABSTRACT

According to some embodiments, a method is performed by a wireless device for timing advance (TA) management between the wireless device and at least one target candidate cell for layer one (L1)/layer two (L2) inter-cell mobility. The wireless device is operating in a serving cell different from the target candidate cell. The method comprises: receiving an uplink configuration for a target candidate cell; transmitting an uplink message to the target candidate cell based on the uplink configuration; and receiving a TA value associated with the target candidate cell. The TA value is received in a message from the serving cell.

### TECHNICAL FIELD

Embodiments of the present disclosure are directed to wireless communications and, more particularly, to time alignment for inter-cell mobility.

### BACKGROUND

Fifth generation (5G) New Radio (NR) is a radio access technology developed by Third Generation Partnership Project (3GPP) for the 5G mobile network. 5G NR wireless networks use timing advance (TA) for uplink synchronization. Different user equipment (UE) in the same cell may typically be located at different positions within the cell and then with different distances to the base station (e.g., NR gNodeB). The transmissions from different UEs thus suffer from different delays until they reach the base station. To ensure that the uplink (UL) transmissions from a UE reach the base station within the corresponding receive window for the base station, an uplink timing control procedure is therefore used. This avoids occurrence of intracell interference, both between UEs assigned to transmit in consecutive subframes and between UEs transmitting on adjacent subcarriers.

Time alignment of the uplink transmissions is achieved by applying a timing advance at the UE transmitter, relative to the received downlink timing. The main role of this is to counteract differing propagation delays between different UEs. An example is illustrated in FIG. 1.

FIG. 1 is a timing diagram illustrating time alignment of uplink transmissions. The illustrated example is for an LTE eNodeB. Case (a) illustrates uplink transmission without timing advance, and case (b) illustrates uplink transmission with timing advance.

To achieve the time alignment, to obtain uplink synchronization, the base station (e.g., gNodeB, eNodeB) derives the timing advance (TA) value that the UE needs to use for the uplink transmissions to reach the base station within the receive window and indicates the TA value to the UE. When the UE first accesses a cell, the UE uses the random-access procedure where the received Msg1 (the physical random access channel (PRACH) preamble) is used by the base station to determine the UE's initial TA to use for uplink transmissions in the cell. During the connection the base station then continuously monitors whether the UE needs to advance/delay the uplink transmissions to compensate for changes in propagation delay, and indicates to the UE if there is a need to change the timing advance value.

When the UE has a connection to several different serving cells, the same TA value can sometimes be used for more than one of those cells, e.g., if they are co-located and thus always would have the same distance to a UE. Such cells can then be configured as belonging to the same timing advance group (TAG). The configuration of TAGs is done per cell group, i.e., serving cells may be configured as belonging to the same TAG only if they belong to the same cell group (master cell group (MCG) or secondary cell group (SCG)). Further details are provided below.

When a UE does not perform uplink transmissions for some time in a serving cell, the TA value that the UE used earlier may no longer be accurate, e.g., because the UE has moved and thus has a different propagation delay. In that case, if the UE performs an uplink transmission using the latest received TA value it may reach the base station outside the receive window and thus not be correctly received by the base station. The transmission may then even be interfering with other uplink transmissions (from other UEs). A timer timeAlignmentTimer is therefore configured for each TAG to indicate how long the UE can consider itself to be uplink time aligned to serving cells belonging to the associated TAG without receiving any updates to the TA value. The timeAlignmentTimer thus indicates a time duration that the UE may consider a received TA value as valid. If the UE does not receive an updated value before timeAlignmentTimer expires, the UE is no longer uplink synchronized to the serving cells belonging to the corresponding TAG.

In TS 38.300, this is summarized as follows for NR:

### 9.2.9 Timing Advance

In RRC_CONNECTED, the gNB is responsible for maintaining the timing advance to keep the L1 synchronised. Serving cells having UL to which the same timing advance applies and using the same timing reference cell are grouped in a TAG. Each TAG contains at least one serving cell with configured uplink, and the mapping of each serving cell to a TAG is configured by RRC.
For the primary TAG the UE uses the PCell as timing reference. In a secondary TAG, the UE may use any of the activated SCells of this TAG as a timing reference cell, but should not change it unless necessary.
Timing advance updates are signalled by the gNB to the UE via MAC CE commands. Such commands restart a TAG-specific timer which indicates whether the L1 can be synchronised or not: when the timer is running, the L1 is considered synchronised, otherwise, the L1 is considered non-synchronised (in which case uplink transmission can only take place on PRACH).

In legacy layer three (L3) mobility, also referred to as a reconfiguration with synchronization for the master cell group (MCG), when the UE changes its PCell, the UE always performs random access with the target PCell. As part of the random access, the UE transmits a preamble in the PRACH in the uplink, which enables the target gNodeB to calculate the TA value for the UE, which is provided in the random access response (RAR) so that from msg3 onwards the UE is able to transmit uplink messages on physical uplink control channel (PUCCH) and/or physical uplink shared channel (PUSCH).

Below is the text from TS 38.321 concerning the initial timing advance configuration during random access procedure:

### 5.1.4 Random Access Response Reception

Once the Random Access Preamble is transmitted and regardless of the possible occurrence of a measurement gap, the MAC entity shall:

```
    [...]
  1>else if a valid (as specified in TS 38.213) downlink assignment has been received on
    the PDCCH for the RA-RNTI and the received TB is successfully decoded:
      [...]
    2>if the Random Access Response reception is considered successful:
      3>if the Random Access Response includes a MAC subPDU with RAPID only:
        [...]
      3>else:
        4>apply the following actions for the Serving Cell where the Random Access
          Preamble was transmitted:
          5>process the received Timing Advance Command (see clause 5.2);
            [...]
[...]
```

### 5.2 Maintenance of Uplink Time Alignment

RRC configures the following parameters for the maintenance of UL time alignment:
timeAlignmentTimer (per TAG) which controls how long the MAC entity considers the Serving Cells belonging to the associated TAG to be uplink time aligned.
   The MAC entity shall:

```
  [...]
1>when a Timing Advance Command is received in a Random Access Response message
  for a Serving Cell belonging to a TAG or in a MSGB for an SpCell:
    [...]
  2>else if the timeAlignmentTimer associated with this TAG is not running:
    3>apply the Timing Advance Command for this TAG;
    3>start the timeAlignmentTimer associated with this TAG;
      [...]
    [...]
```

The MAC entity shall not perform any uplink transmission on a Serving Cell except the Random Access Preamble and MSGA transmission when the timeAlignmentTimer associated with the TAG to which this Serving Cell belongs is not running. Furthermore, when the timeAlignmentTimer associated with the PTAG is not running, the MAC entity shall not perform any uplink transmission on any Serving Cell except the Random Access Preamble and MSGA transmission on the SpCell.
[ . . . ]

### 6.2.3 MAC Payload for Random Access Response

The MAC RAR is of fixed size as depicted in FIG. 6.2.3-1, and consists of the following fields:
R: Reserved bit, set to “0”;
Timing Advance Command: The Timing Advance Command field indicates the index value T_{A} used to control the amount of timing adjustment that the MAC entity has to apply in TS 38.213. The size of the Timing Advance Command field is 12 bits;
[ . . . ]
   The MAC RAR is octet aligned.
   <FIG. 6.2.3-1: MAC RAR is reproduced as FIG. 2.
   [ . . . ]

### 6.1.3.4 Timing Advance Command MAC CE

The Timing Advance Command MAC CE is identified by MAC subheader with LCID as specified in Table 6.2.1-1.
It has a fixed size and consists of a single octet defined as follows (FIG. 6.1.3.4-1):
TAG Identity (TAG ID): This field indicates the TAG Identity of the addressed TAG. The TAG containing the SpCell has the TAG Identity 0. The length of the field is 2 bits;
Timing Advance Command: This field indicates the index value T_{A} (0, 1, 2 . . . 63) used to control the amount of timing adjustment that MAC entity has to apply (as specified in TS 38.213 [6]). The length of the field is 6 bits.
<FIG. 6.1.3.4-1: Timing Advance Command MAC CE is reproduced as FIG. 3>
   [38.213]

### 4.2 Transmission Timing Adjustments

[ . . . ]
Upon reception of a timing advance command for a TAG, the UE adjusts uplink timing for PUSCH/SRS/PUCCH transmission on all the serving cells in the TAG based on a value N_{TA, offset} that the UE expects to be same for all the serving cells in the TAG and based on the received timing advance command where the uplink timing for PUSCH/SRS/PUCCH transmissions is the same for all the serving cells in the TAG.

After the UE is configured with its serving cell(s) for a given cell group (e.g., master cell group—MCG and/or secondary cell group—SCG), the UE obtains the initial TA value via random access response (RAR), and is configured with the association between serving cells and TAG identifiers, the UE needs to maintain the time alignment according to the TA procedure defined in section 5.2 in TS 38.321. TA is adjusted while the UE is connected to a serving cell either by an explicit medium access control (MAC) control element (CE) from the network (e.g., if the network detects a possible misalignment) and/or by the UE (e.g., when the time alignment timer timeAlignmentTimer for a given TAG expires).

Upon reception of the Timing Advance Command (which is a MAC CE) the UE applies the command (including new value(s)) and starts/re-starts the TA timer. Further details of the maintenance procedure, after the initial TA is shown below:

Timing Advance Group: A group of Serving Cells that is configured by RRC and that, for the cells with a UL configured, using the same timing reference cell and the same Timing Advance value. A Timing Advance Group containing the SpCell of a MAC entity is referred to as Primary Timing Advance Group (PTAG), whereas the term Secondary Timing Advance Group (STAG) refers to other TAGs.
[ . . . ]

### 5.2 Maintenance of Uplink Time Alignment

The MAC entity shall:
1>when a Timing Advance Command MAC CE is received, and if an N_{TA} (as defined in TS 38.211) has been maintained with the indicated TAG:

```
  2>apply the Timing Advance Command for the indicated TAG;
  2>start or restart the timeAlignmentTimer associated with the indicated TAG.
    [...]
1>when a timeAlignmentTimer expires:
  2>if the timeAlignmentTimer is associated with the PTAG:
      3>flush all HARQ buffers for all Serving Cells;
      3>notify RRC to release PUCCH for all Serving Cells, if configured;
      3>notify RRC to release SRS for all Serving Cells, if configured;
      3>clear any configured downlink assignments and configured uplink grants;
      3>clear any PUSCH resource for semi-persistent CSI reporting;
      3>consider all running timeAlignmentTimers as expired;
      3>maintain N_{TA} (defined in TS 38.211 [8]) of all TAGs.
  2>else if the timeAlignmentTimer is associated with an STAG, then for all Serving
      Cells belonging to this TAG:
      3>flush all HARQ buffers;
      3>notify RRC to release PUCCH, if configured;
      3>notify RRC to release SRS, if configured;
      3>clear any configured downlink assignments and configured uplink grants;
      3>clear any PUSCH resource for semi-persistent CSI reporting;
      3>maintain N_{TA} (defined in TS 38.211) of this TAG.
```

When the MAC entity stops uplink transmissions for an SCell due to the fact that the maximum uplink transmission timing difference between TAGs of the MAC entity or the maximum uplink transmission timing difference between TAGs of any MAC entity of the UE is exceeded, the MAC entity considers the timeAlignmentTimer associated with the SCell as expired.
The MAC entity shall not perform any uplink transmission on a Serving Cell except the Random Access Preamble and MSGA transmission when the timeAlignmentTimer associated with the TAG to which this Serving Cell belongs is not running. Furthermore, when the timeAlignmentTimer associated with the PTAG is not running, the MAC entity shall not perform any uplink transmission on any Serving Cell except the Random Access Preamble and MSGA transmission on the SpCell.

3GPP Rel-18 includes a work item (WI) on further NR mobility enhancements, in particular, in a technical area entitled layer one (L1)/layer two (L2) based inter-cell mobility. The WI description (WID) in RP-213565 includes further details.

According to the WID, when a UE moves from the coverage area of one cell to another cell, at some point a serving cell change needs to be performed. Currently serving cell change is triggered by L3 measurements and is done by RRC signaling triggered Reconfiguration with Synchronization for change of PCell and PSCell, as well as release add for SCells when applicable. All cases involve complete L2 (and L1) resets, leading to longer latency, larger overhead and longer interruption time than beam switch mobility. The goal of L1/L2 mobility enhancements is to enable a serving cell change via L1/L2 signaling, to reduce the latency, overhead and interruption time.

L1-L2 inter-cell mobility should be if possible like an inter-cell beam management, i.e., to support L1-L2 inter-cell mobility the UE should be configured to perform measurements on cells that are not the serving cells as defined up to Rel-17.

In Rel-17, to support inter-PCI mTRP operation, a solution has been standardized where a CSI resource may be associated to a physical cell identifier (PCI) that is not the same PCI of one of the serving cells. That solution also requires the UE to receive an explicit indication of which beams (SSBs) and PCIs to be measured for a given reporting configuration.

The goal is to specify a mechanism and procedures of L1/L2 based inter-cell mobility for mobility latency reduction. These include: configuration and maintenance for multiple candidate cells to allow fast application of configurations for candidate cells; a dynamic switch mechanism among candidate serving cells (including SpCell and SCell) for the potential applicable scenarios based on L1/L2 signaling; L1 enhancements for inter-cell beam management, including L1 measurement and reporting and beam indication; timing advance management; and CU-DU interface signaling to support L1/L2 mobility.

The procedure of L1/L2 based inter-cell mobility are applicable to the following scenarios: standalone, CA and NR-DC case with serving cell change within one CG; intra-DU case and intra-CU inter-DU case (applicable for Standalone and CA); both intra-frequency and inter-frequency; both FR1 and FR2; and source and target cells may be synchronized or non-synchronized.

There currently exist certain challenges. For example, one of the issues to resolve for L1/L2 inter-cell mobility is the timing advance management. In legacy L3 handover, the timing advance is established between the UE and the target cell with a random access procedure, by the UE transmitting a preamble and receiving in the RAR a TA value.

If random access would have always been performed with the target candidate cell for L1/L2 inter-cell mobility the same solution as in legacy L3 handover could be adopted. However, it is desired in L1/L2 inter-cell mobility execution to reduce as much as possible the interruption time, which means that most likely there will be specified a solution in which the UE does not perform random access with the target cell at the moment of the L1/L2 inter-cell mobility execution. That means that either such a target candidate cell needs to be uplink synchronized or the existing solution is not applicable.

One solution is based on the UE performing a random access procedure with a target candidate cell to obtain a TA value per at least one target candidate cell for L1/L2 inter-cell mobility, and possibly manage a TA timer to monitor whether the TA value is valid (while the timer is running). One benefit of the solution is that it still relies on a random-access procedure with a given cell (target candidate cell for L1/L2 inter-cell mobility), which means that what differs is mainly the trigger for the procedure, which occurs before the execution so the UE is prepared to later execute mobility without the need of random access, as it is uplink synchronized. An example is illustrated in FIG. 4.

FIG. 4 is a signaling diagram illustrating an example of performing a random access procedure with a target candidate cell to obtain a TA value for L1/L2 inter-cell mobility. Despite its benefits, however, to perform random access in the target candidate cell the UE needs to transmit a preamble and wait for the RAR, as illustrated, and in most scenarios that significantly increases the interruption with the PCell, which in turn reduces the data rates with the PCell for the sake of preparing one or multiple cells for L1/L2 inter-cell mobility.

### SUMMARY

As described above, certain challenges currently exist with time alignment for inter-cell mobility. Certain aspects of the present disclosure and their embodiments may provide solutions to these or other challenges. For example, particular embodiments include establishment of timing advance (TA) with respect to a user equipment (UE). The following are some example embodiments.

Embodiment A1: A method at a UE for TA management between the UE and at least one target candidate cell for layer one (L1)/layer two (L2) inter-cell mobility. The method comprises receiving an uplink configuration for a target candidate cell; transmitting an uplink message to the target candidate cell based on the uplink configuration; and receiving a TA value associated to the target candidate cell, wherein the TA value is received in a message from the serving cell.

Embodiment A2. The TA value associated to the target candidate cell received via the serving cell is received in the L1/L2 inter-cell mobility command indicating that the UE shall execute L1/L2 inter-cell mobility to that target candidate cell.

Embodiment A3. The TA value associated to the target candidate cell received via the serving cell is received in a Radio Resource Control (RRC) Reconfiguration received after the UE has been configured with L1/L2 inter-cell mobility and after the UE has transmitted the uplink message to the target candidate cell.

Embodiment A3b. The TA value associated to the target candidate cell received via the serving cell is received within a lower layer signaling (e.g., medium access control (MAC) control element (CE), downlink control information (DCI)).

Embodiment A3c. The TA value associated to the target candidate cell received via the serving cell is received within an RRC message (e.g., RRCReconfiguration message).

Embodiment A4. The uplink configuration for a target candidate cell is received from a first network node, wherein the first network node corresponds to a serving distributed unit (DU).

Embodiment A5. The uplink configuration for a target candidate cell is generated by a candidate DU, associated to the target candidate cell configured for L1/L2 inter-cell mobility.

Embodiment A6. The TA value associated to the target candidate cell is received from a first network node, wherein the first network node corresponds to the serving DU.

Embodiment A7. The uplink configuration for a target candidate cell is a Random Access Channel configuration for the target candidate cell.

Embodiment A8. The uplink message to the target candidate cell based on the uplink configuration is a random access preamble, associated to one or more synchronization signal blocks 1 (SSBs) and/or channel state information reference signal (CSI-RS) resources.

Embodiment A8a. The uplink message to the target candidate cell based on the uplink configuration is a sounding reference signal (SRS).

Embodiment A9. (Re-establishment/update of TA) The method may further comprise receiving an update of the uplink configuration for a target candidate cell and transmitting an uplink message to the target candidate cell based on the updated uplink configuration and receiving a TA value associated to the target candidate cell, wherein the TA value is received in a message from the serving cell.

Embodiment A10. The uplink configuration includes a trigger condition for sending the uplink message to the target candidate cell.

Embodiment A11. The trigger condition is a measurement event, e.g. Event A2, A3, A4 or A5.

Embodiment A12. The trigger condition includes a timer, which is started at uplink message transmission, and where expiry of the timer triggers a retransmission of the uplink message.

Some embodiments include establishment of TA with respect to a candidate DU.

Embodiment B1. A method at a candidate DU for TA management between the ULE and at least one target candidate cell for L1/L2 inter-cell mobility of the candidate DU. The method comprises: receiving from a central unit (CU) a request requesting the TA establishment for a UE and at least one target candidate cell; transmitting to the CU an uplink configuration for a target candidate cell and the UE; receiving from the UE an uplink message based on the uplink configuration; and calculating a TA value associated to the target candidate cell and transmitting the TA value to the CU.

Embodiment B2. The candidate DU transmits to the CU an uplink configuration for a target candidate cell and the UE when requested to provide a L1/L2 inter-cell candidate cell configuration. Therefore, there is not explicit request for providing a TA establishment but the candidate DU sends this directly when requested by the CU to set a candidate cell for L1/L2 inter-cell mobility.

Some embodiments include establishment of TA with respect to a CU.

Embodiment C1. A method at a CU for TA management between the UE and at least one target candidate cell for L1/L2 inter-cell mobility. The method comprises: transmitting a request to a candidate DU, requesting the TA establishment for a UE and at least one target candidate cell; receiving from the candidate DU an uplink configuration for a target candidate cell and the UE; transmitting an uplink message to the serving DU to be transmitted to the UE, wherein the uplink message comprises the uplink configuration; receiving from the candidate DU a TA value associated to the target candidate cell; and transmitting to the serving DU (to be provided to the UE) the TA value.

Some embodiments include re-establishment of TA with respect to a CU, candidate DU and serving DU.

Embodiment D1. A method at the UE for re-establishing/maintaining an existing TA value between the UE and at least one target candidate cell for L1/L2 inter-cell mobility. The method comprises starting a timer when receiving a TA value associated to a target candidate cell. Upon the expiry of the timer related to the validity of the TA value, the method comprises transmitting an uplink message to the serving DU for requesting a new TA value related to a target candidate cell. Alternatively, transmitting an uplink message to the target candidate cell based on the uplink configuration previously received. The method further comprises receiving a TA value associated to the target candidate cell, wherein the TA value is received in a message from the serving cell.

Embodiment D2. The timer started when receiving a TA value may be common for all the TA values that the UE is currently maintaining or is a single timer for each of the TA values that the UE is maintaining. Further, the timer may be a value for a group of TA values, e.g., belonging to the same candidate DU.

Embodiment E1. A method at the serving DU for re-establishing/maintaining an existing TA value between the UE and at least one target candidate cell for L1/L2 inter-cell mobility. The method comprises starting a timer when transmitting a TA value to the UE associated to a target candidate cell. Upon the expiry of the timer related to the validity of the TA value, the method further comprises transmitting a message to the serving DU (via the CU) for requesting a new TA value related to a target candidate cell. Alternatively, transmitting a message to the CU for requesting a new TA value related to a target candidate cell. The method further comprises receiving a TA value associated to the target candidate cell, wherein the TA value is received in a message from CU and transmitting the new TA value that is associated to the target candidate cell to the UE.

Embodiment E2. The timer started when receiving a TA value may be common for all the TA values that the UE is currently maintaining or is a single timer for each of the TA values that the UE is maintaining. Further, the timer may be a value for a group of TA values, e.g., belonging to the same candidate DU.

Embodiment F1. A method at the CU for re-establishing/maintaining an existing TA value between the UE and at least one target candidate cell for L1/L2 inter-cell mobility. The method comprises starting a timer when transmitting a TA value to the serving DU to be sent to UE and that is associated to a target candidate cell. Upon the expiry of the timer related to the validity of the TA value, transmitting a message to the candidate DU for requesting a new TA value related to a target candidate cell. The method further comprises receiving a TA value associated to the target candidate cell, wherein the TA value is received in a message from the candidate DU and transmitting the new TA value to the serving DU to be sent to the UE.

Embodiment F2. The timer started when receiving a TA value may be common for all the TA values that the UE is currently maintaining or is a single timer for each of the TA values that the UE is maintaining. Further, the timer may be a value for a group of TA values, e.g., belonging to the same candidate DU.

Embodiment G1. A method at the candidate DU for re-establishing/maintaining an existing TA value between the UE and at least one target candidate cell for L1/L2 inter-cell mobility. The method comprises starting a timer when transmitting a TA value to the CU (or to the Serving DU via the CU) to be sent to the UE and that is associated to a target candidate cell. Upon the expiry of the timer related to the validity of the TA value, the method further comprises transmitting a message to the CU (or to the serving DU via the CU) including a new TA value related to a target candidate cell to be sent to the UE.

Embodiment G2. The timer started when receiving a TA value may be common for all the TA values that the UE is currently maintaining or is a single timer for each of the TA values that the UE is maintaining. Further, the timer may be value for a group of TA values, e.g., belonging to the same candidate DU.

According to some embodiments, a method is performed by a wireless device for TA management between the wireless device and at least one target candidate cell for L1/L2 inter-cell mobility. The wireless device is operating in a serving cell different from the target candidate cell. The method comprises: receiving an uplink configuration for a target candidate cell; transmitting an uplink message to the target candidate cell based on the uplink configuration; and receiving a TA value associated with the target candidate cell. The TA value is received in a message from the serving cell.

In particular embodiments, the TA value associated with the target candidate cell received via the serving cell is received in a L1/L2 inter-cell mobility command indicating that the wireless device shall execute L1/L2 inter-cell mobility to the target candidate cell or is received in a RRC Reconfiguration received after the wireless device has been configured with L1/L2 inter-cell mobility and after the UE has transmitted the uplink message to the target candidate cell.

In particular embodiments, the uplink configuration for the target candidate cell is received from a first network node, wherein the first network node corresponds to a serving DU. The uplink configuration for a target candidate cell is generated by a candidate DU associated with the target candidate cell configured for L1/L2 inter-cell mobility.

In particular embodiments, the TA value associated with the target candidate cell is received from a first network node, wherein the first network node corresponds to a serving DU.

In particular embodiments, the uplink configuration for the target candidate cell comprises a RACH configuration for the target candidate cell.

In particular embodiments, the uplink message transmitted to the target candidate cell based on the uplink configuration comprises a random access preamble associated to one or more SSBs and CSI-RS resources.

In particular embodiments, the uplink message transmitted to the target candidate cell based on the uplink configuration comprises a SRS.

In particular embodiments, the uplink configuration includes a trigger condition for sending the uplink message to the target candidate cell. The uplink configuration may be associated with a validity time.

In particular embodiments, receiving the uplink configuration for the target candidate cell comprises receiving the uplink configuration for the target candidate cell in a first message and transmitting the uplink message to the target candidate cell comprises transmitting the uplink message to the target candidate cell in response to reception of a second message. The first message may comprise a RRC message and the second message comprises a PDCCH order. The second message is received by the wireless device after the wireless device has received the first message.

In particular embodiments, the method further comprises: receiving an update of the uplink configuration for the target candidate cell; transmitting an uplink message to the target candidate cell based on the updated uplink configuration; and receiving a TA value associated with the target candidate cell. The TA value is received in a message from the serving cell.

In particular embodiments, the method further comprises: in response to receiving the uplink configuration for the target candidate cell, starting a timer; in response to expiry of the timer, transmitting an uplink message to the target candidate cell; and receiving a TA value associated with the target candidate cell. The TA value is received in a message from the serving cell.

In particular embodiments, transmitting the uplink message to the target candidate cell is based on the received uplink configuration.

In particular embodiments, L1/L2 inter-cell mobility comprises receiving signaling indicating a change of serving cell via a signaling layer that is a lower layer than a RRC layer in a protocol stack.

According to some embodiments, a wireless device comprises processing circuitry operable to perform any of the methods of the wireless device described above.

Also disclosed is a computer program product comprising a non-transitory computer readable medium storing computer readable program code, the computer readable program code operable, when executed by processing circuitry to perform any of the methods performed by the wireless receiver described above.

According to some embodiments, a method is performed by a network node operating as a candidate DU for TA management between a wireless device and at least one target candidate cell for L1/L2 inter-cell mobility of the candidate DU. The method comprises: receiving, from a serving CU, a message requesting TA establishment for the wireless device and at least one target candidate cell; transmitting, to the serving CU, an uplink configuration for a target candidate cell and the wireless device; receiving, from the wireless device, an uplink message based on the uplink configuration; and transmitting, to the wireless device via the serving CU, a TA value associated with the target candidate cell and calculated based on the received uplink message.

In particular embodiments, the message requesting TA establishment for the wireless device comprises a request to provide a L1/L2 inter-cell candidate cell configuration.

In particular embodiments, the method further comprises: in response to transmitting the TA value to the wireless device, starting a timer; and in response to expiry of the timer, transmitting, to the wireless device via the serving CU, a new TA value associated with the target candidate cell.

According to some embodiments, a method is performed by a network node operating as a serving CU for TA management between a wireless device and at least one target candidate cell for L1/L2 inter-cell mobility. The method comprises: transmitting a request to a candidate DU requesting TA establishment for the wireless device and at least one target candidate cell; receiving from the candidate DU an uplink configuration for a target candidate cell and the wireless device; and transmitting an uplink message to a serving DU to be transmitted to the wireless device. The uplink message comprises the uplink configuration. The method further comprises receiving from the candidate DU a TA value associated to the target candidate cell and transmitting to the wireless device via the serving DU the TA value.

In particular embodiments, the message requesting TA establishment for the wireless device comprises a request to provide a L1/L2 inter-cell candidate cell configuration.

In particular embodiments, the method further comprises: in response to transmitting the TA value to the wireless device, starting a timer; and in response to expiry of the timer, transmitting a request to the candidate DU requesting new TA establishment for the wireless device and at least one target candidate cell.

According to some embodiments, a network node comprises processing circuitry operable to perform any of the methods of network nodes described above.

Also disclosed is a computer program product comprising a non-transitory computer readable medium storing computer readable program code, the computer readable program code operable, when executed by processing circuitry to perform any of the methods performed by the network nodes described above.

Certain embodiments may provide one or more of the following technical advantages. For example, in particular embodiments the uplink configuration is a random access channel (RACH) configuration, based on which the UE transmits a preamble to a target candidate cell, e.g., when that cell is configured as a L1/L2 inter-cell mobility candidate. However, because the transmission or possible receptions in the target candidate may lead to interruptions in UE communication with the serving DU, the UE does not expect a random Access response from the target candidate cell. Instead, according to the method, the candidate DU that receives the preamble calculates the TA and provides to the serving DU, which provides the TA to the UE, e.g., at the moment of L1/L2 inter-cell mobility execution.

In summary, a benefit is the possibility to execute L1/L2 inter-cell mobility without the need to perform random access during the execution, which reduces the mobility interruption time. In addition, because the TA value is not received in a RAR and/or MAC CE from the target candidate, but from the serving DU (via serving cell, e.g., in a downlink channel of a serving cell), the interruption in the communication between the UE and the serving DU is minimized to the time to transmit the uplink message.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a timing diagram illustrating time alignment of uplink transmissions;

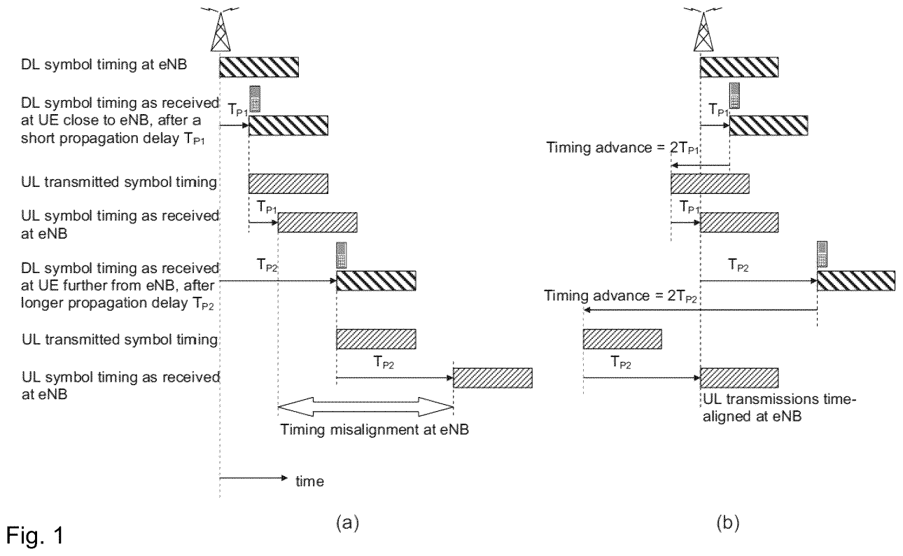

FIG. 2 illustrates a medium access control (MAC) random access response (RAR) reproduced from FIG. 6.2.3-1 in TS 38.321;

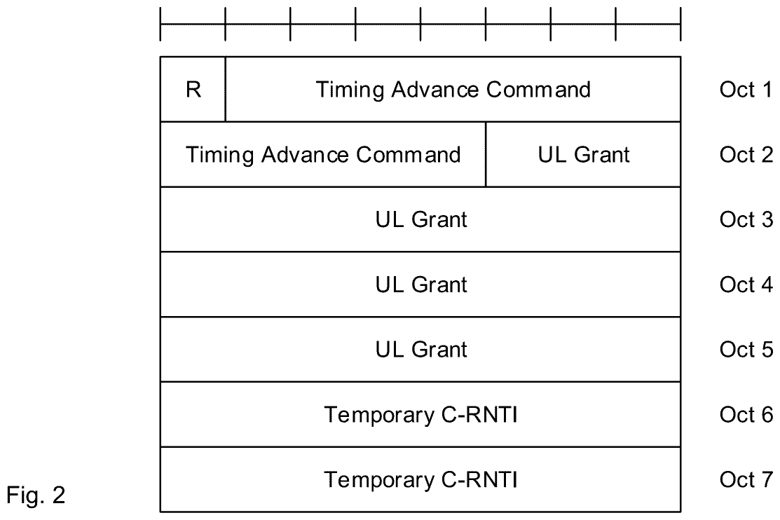

FIG. 3 illustrates a timing advance command MAC control element (CE) reproduced from FIG. 6.1.3.4-1 in TS 38.321;

FIG. 4 is a signaling diagram illustrating an example of performing a random access procedure with a target candidate cell to obtain a timing advance (TA) value for L1/L2 inter-cell mobility;

FIG. 5 is a block diagram illustrating the architecture of a central unit (CU) and a distributed unit (DU) in a radio access network (RAN);

FIG. 6 illustrates example Radio Resource Control (RRC) configuration for the target candidate configuration;

FIG. 7 is signaling diagram illustrating TA establishment for target candidate cell(s);

FIG. 8 is a signaling diagram illustrating an example of TA re-establishment/update with target candidate cell(s);

FIG. 9 is a signaling diagram illustrating an example of candidate DU-initiated TA update;

FIG. 10 is a signaling diagram illustrating an example of serving DU-initiated TA update;

FIG. 11 illustrates an example communication system, according to certain embodiments;

FIG. 12 illustrates an example user equipment (UE), according to certain embodiments;

FIG. 13 illustrates an example network node, according to certain embodiments;

FIG. 14 illustrates a block diagram of a host, according to certain embodiments;

FIG. 15 illustrates a virtualization environment in which functions implemented by some embodiments may be virtualized, according to certain embodiments;

FIG. 16 illustrates a host communicating via a network node with a UE over a partially wireless connection, according to certain embodiments;

FIG. 17 illustrates a method performed by a wireless device, according to certain embodiments;

FIG. 18 illustrates a method performed by a serving network node, according to certain embodiments; and

FIG. 19 illustrates a method performed by a candidate network node, according to certain embodiments.

### DETAILED DESCRIPTION

As described above, certain challenges currently exist with time alignment for layer one (L1)/layer two (L2) inter-cell mobility. Certain aspects of the present disclosure and their embodiments may provide solutions to these or other challenges. For example, particular embodiments include establishment of timing advance (TA) with respect to a user equipment (UE) and at least one target candidate cell.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

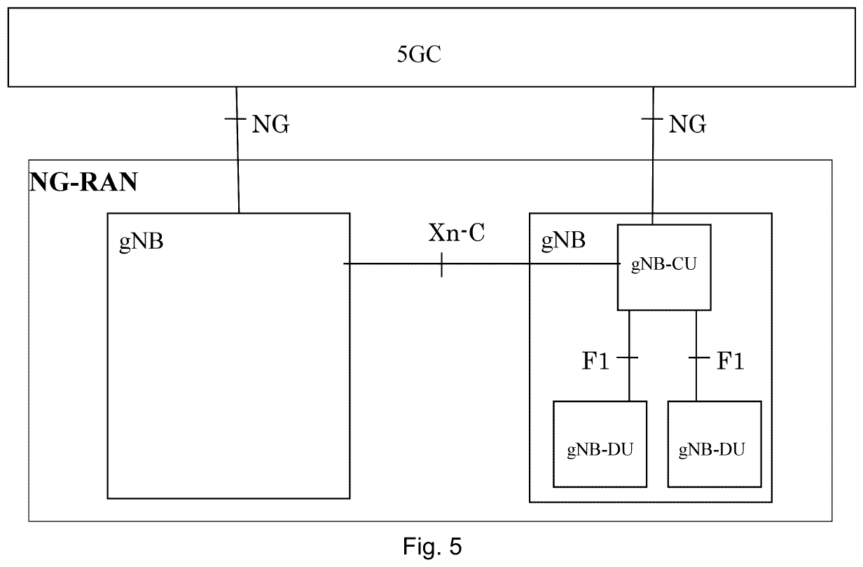

FIG. 5 is a block diagram illustrating the architecture of a central unit (CU) and a distributed unit (DU) in a radio access network (RAN). The example architecture illustrates both next generation RAN (NG-RAN) and the 5G core network (5GC) with the NG-RAN split in CU and DU connected via F1 interface. The illustrated example includes the NG-RAN, which may be referred as the 5G RAN, however, particular embodiments are applicable to any RAN such as a 6G RAN architecture.

The RAN (e.g., NG-RAN) consists of a set of RAN nodes (e.g. gNBs) connected to a core network (e.g., a 5GC) through a RAN/CN interface (e.g., NG interface). For NG-RAN, that may comprise one or more ng-eNBs, wherein an ng-eNB may consist of an ng-eNB-CU and one or more ng-eNB-DU(s). A gNB may consist of a gNB-CU and one or more gNB-DU(s). A gNB-CU and a gNB-DU is connected via F1 interface. A gNB-DU may be connected to multiple gNB-CUs by appropriate implementation.

NG, Xn and F1 are logical interfaces. For the NG-RAN, the NG and Xn-C interfaces for a gNB consisting of a gNB-CU and gNB-DUs, terminate in the gNB-CU. For EN-DC, the S1-U and X2-C interfaces for a gNB consisting of a gNB-CU and gNB-DUs, terminate in the gNB-CU. The gNB-CU and connected gNB-DUs are only visible to other gNBs and the 5GC as a gNB.

The term “L1/L2 based inter-cell mobility” is used as in the Work Item Description in 3GPP, though the terms L1/L2 mobility, L1-mobility, L1 based mobility, L1/L2-centric inter-cell mobility or L1/L2 inter-cell mobility may also be used interchangeably herein. The basic principle is that the UE receives a lower layer signaling from the network indicating to the UE a change (or switch or activation) of its serving cell (e.g., change of PCell, from a source to a target PCell), wherein a lower layer signaling is a message/signaling of a lower layer protocol, which may be referred as a L1/L2 inter-cell mobility execution command. The change of serving cell (e.g., change of PCell) may also lead to a change in Scell(s) for the same cell group, e.g., if the command triggers the UE to change to another cell group configuration of the same type (e.g., another master cell group (MCG) configuration).

A lower layer protocol refers to a lower layer protocol in the air interface protocol stack compared to Radio Resource Control (RRC) protocol, e.g., medium access control (MAC) is considered a lower layer protocol because it is below RRC in the air interface protocol stack, and a lower layer signaling/message may correspond to a MAC control element (CE). Another example of lower layer protocol is the Layer 1 (or Physical Layer, L1), and a lower layer signaling/message may correspond to downlink control information (DCI). Signaling information in a protocol layer lower than RRC reduces the processing time and, consequently, reduces the interruption time during mobility. In addition, it may also increase the mobility robustness as the network may respond faster to changes in the channel conditions.

Another relevant aspect in L1/L2 inter-cell mobility is that in a multi-beam scenario, a cell can be associated to multiple synchronization signal blocks (SSBs), and during a half-frame, different SSBs may be transmitted in different spatial directions (i.e., using different beams, spanning the coverage area of a cell). Similar reasoning may be applicable to channel state information reference signal (CSI-RS) resources, which may also be transmitted in different spatial directions. Thus, in L1/L2 inter-cell mobility, the reception of lower layer signaling indicates the UE to change from one beam in the serving cell, to another beam in a neighbor cell (which is a configured candidate cell), and thus changing serving cell.

The term target candidate configuration refers to the configuration of a “L1/L2 inter-cell mobility candidate cell”, which is a cell the UE is configured with when configured with L1/L2 inter-cell mobility. In other words, the target cell is a cell the UE can move to in a L1/L2 inter-cell mobility procedure upon reception of lower layer signaling. These cells may also be referred to as candidate cell(s), candidates, mobility candidates, non-serving cells, additional cells, target candidate cell, target candidate, etc. This is a cell the UE performs measurements on (e.g., channel state information (CSI) measurements) so that the UE reports these measurements and the network may make an educated decision on which beam (e.g., transmission configuration indicator (TCI) state) and/or cell the UE is to be switched to. A L1/L2 inter-cell mobility candidate cell may be a candidate to be a target PCell or PSCell, or an SCell of a cell group (e.g., MCG SCell).

The actual target candidate configuration and its content and/or structure of the IE and/or embedded message may be referred to as an RRC model for the candidate configuration, or simply RRC model. A target candidate configuration comprises the configuration that the UE uses to operate accordingly when the UE performs (executes) L1/L2 inter-cell mobility execution to the target candidate cell upon reception of the lower layer signaling indicating a L1/L2 based inter-cell mobility to the target candidate cell (which becomes the target cell and the current (new) PCell, or an SCell in a serving frequency). The UE may be configured with multiple target candidate cells, so a candidate DU generates and sends to the CU multiple configuration(s). The target candidate configuration comprises at least parameters of a serving cell (or multiple serving cells) comprising one or more of the groups of parameters within the IE SpCellConfig (or the IE SCellConfig, for a secondary cell).

Some examples of how the signaling may be implemented in RRC for the target candidate configuration are described as RRC models for L1/L2 based inter-cell mobility:

a) RRC Reconfiguration per candidate cell. In this case the UE receives multiple (a list of) RRC messages (i.e., RRCReconfiguration message) within a single RRCReconfiguration message. Each RRCReconfiguration message identifies a target candidate configuration that is stored by the UE and is applied/used/activated when receiving the lower layer signaling for L1/L2 inter-cell mobility. This model enables the full flexibility, as in L3 reconfigurations, for the target node to modify/release/keep any parameter/field in the RRCReconfiguration message such as measurement configuration, bearers, etc.

b) CellGroupConfig per candidate cell. With this model the UE receives within an RRCReconfiguration a list of CellGroupConfig IEs and each one of them identify a target candidate configuration. Each CellGroupConfig IE is stored at the UE and is applied/used/activated when receiving the lower layer signaling for L1/L2 inter-cell mobility. This model enables the target node to modify/release/keep any parameter/field that is part of a CellGroupConfig IE while the rest of the RRCReconfiguration message (that is where the CellGroupConfig IE is received by the UE) remain unchanged. This means that e.g., measurement configuration, bearers, and security remain the same and are not changed by the target node.

c), d), and e) “K” SpCellConfig or “K” ServingCellConfigCommon, or both per cell. With this model the UE receives either “K” SpCellConfig per cell (option c), “K” ServingCellConfigCommon per cell (option e), or “K” SpCellConfig and “K” ServingCellConfigCommon per cell (option d) as a target candidate configuration. This solution provides only minimum flexibility for the target node because only cell-specific parameters (e.g., bandwidth parts, downlink, and uplink configurations) can be modified/released/kept.

f) “K” PCI in the same PCell. With this model multiple physical cell identifiers (PCIs) are configured for the same TCI state configuration where each PCI identifies a target candidate configuration. This approach provides no flexibility because all the parameters/fields used for configuring a target candidate configuration are fixed and only a change of PCI, scrambling identifier, and cell radio network temporary identifier (C-RNTI) is possible for the target node.

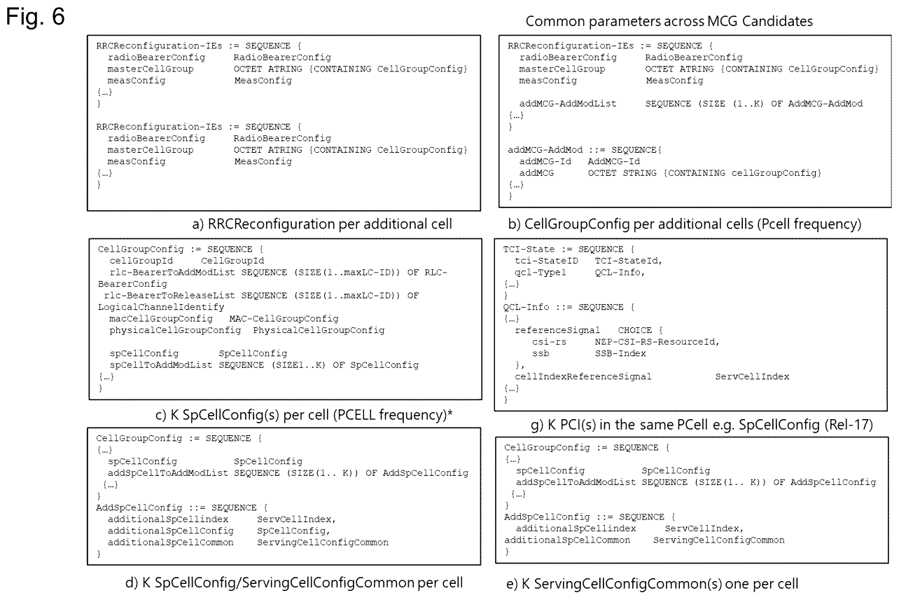

FIG. 6 illustrates example RRC configuration for the target candidate configuration. The illustrated examples include examples of a-f described above.

The L1/L2 inter-cell mobility configuration may correspond to a field and/or information element defined in RRC protocol (e.g., in ASN.1 format) comprising one or more target candidate cell configuration(s). The L1/L2 inter-cell mobility configuration may comprise multiple target candidate cell configuration(s) when the UE is configured with multiple target candidate cell(s) for L1/L2 inter-cell mobility. That L1/L2 inter-cell mobility configuration may be included in an RRCReconfiguration message (as defined in 3GPP TS 38.331), or an RRC Resume message the UE receives, e.g., during a state transition to RRC_CONNECTED.

The L1/L2 inter-cell mobility configuration may be generated by a central unit (CU), e.g. gNB-CU, and include information generated and transmitted from a candidate distributed unit (DU), such as the target candidate cell configuration and/or a measurement configuration indicating the UE to perform measurements on reference signals, e.g. SSBs and/or CSI-RS resources, of a target candidate cell, for reporting to the network to assist L1/L2 inter-cell mobility execution decisions.

The target candidate cell configuration comprises the configuration based on which the UE operates in the target candidate cell if that cell is indicated as a target cell in the L1/L2 inter-cell mobility execution command.

Some embodiments include TA establishment for target candidate cell(s) for L1/L2 inter-cell mobility. In the following, a possible signaling flow is used to illustrate the general idea of the method and various set of embodiments showing different alternatives for the actions in the UE, the serving DU, a candidate DU and the CU.

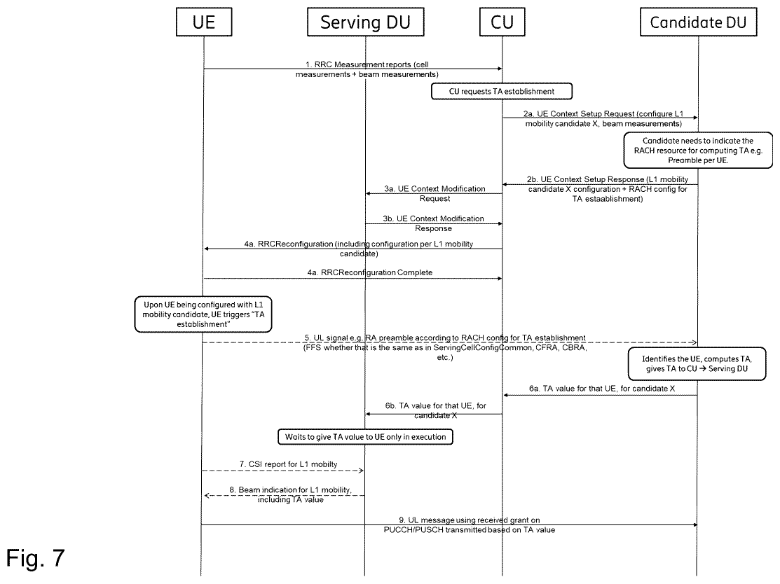

FIG. 7 is signaling diagram illustrating TA establishment for target candidate cell(s). In the illustrated example in general, when the UE is configured with an L1/L2 mobility candidate, the UE sends an uplink signal to the candidate DU and the candidate DU computes the TA value based on the uplink signal. The candidate DU then provides the TA value to the serving DU for use in the L1/L3 mobility execution.

In a set of embodiments, a UE transmits an RRC Measurement Report message (e.g., step 1 of FIG. 7) to the network (e.g., CU) including measurements on one or more neighbor cells (e.g., cell based reference signal receive power (RSRP), reference signal receive quality (RSRQ) and/or signal to interference and noise ratio (SINR)), in a frequency, wherein a neighbor cell, possibly including beam measurement information (to be later used for configuring the TA establishing procedure). The report is transmitted in response to a network configuration: the UE is configured by the network (e.g., by the CU) to transmit RRC measurement reports (e.g. based on the fulfillment of conditions associated to A3 and/or A5 measurement events, as defined in TS 38.331) including neighbor cells and serving cells.

The UE includes in the RRC Measurement Report (based on the measurement configuration) beam measurement information for the one or more neighbor cells, such as RSRP and/or RSRQ and/or SINR of one or more beams (e.g., of one or more SSBs and/or CSI-RS resources) of a neighbor cell with associated beam identifiers (e.g., SSB indexes and/or CSI-RS resource identifiers) or only beam identifiers, depending on the reporting configuration.

The network (e.g., the CU, CU-gNB) determines to configure the UE with L1/L2 inter-cell mobility. It may determine to request the configuration of one or more neighbor cell(s) included in the RRC measurement report as target candidate cells for L1/L2 inter-cell mobility.

In a set of embodiments, the CU (e.g., CU-gNB, gNB) transmits a request message to a Candidate DU (e.g., Candidate gNB-DU, via the CU) to configure L1/L2 inter-cell mobility for at least one target candidate cell. In one option, the same request is used for a plurality of target candidate cell(s) of the same candidate DU; in one option there is a request per target candidate cell, even if the request is a request for cells of the same candidate DU; in one option the CU transmits requests for multiple candidate DU(s), one per target candidate cell and/or one for multiple target candidate cell(s) in the same candidate DU. A requested target candidate cell may be one of the neighbor cells included in the RRC measurement report the CU may have received.

In one set of embodiments, the CU further requests to the candidate DU the establishment of the TA between the UE and the least one of its target candidate cell(s) (e.g., step 2a of FIG. 7), for example, by including an indication for that in the request message described above. When the CU determines to configure L1/L2 inter-cell mobility for at least one target candidate cell in a candidate DU, the CU determines that the UE is not synchronized in the uplink (UL) with the at least one target candidate cell and decides to request the TA establishment to the candidate DU (responsible for that target candidate cell). That may be referred to as a CU-initiated TA establishment for L1/L2 inter-cell mobility.

In one embodiment, the CU includes a TA establishment request per target candidate cell for which it wants TA to be established, e.g., if they are in different candidate DU(s), or in the same candidate DU but different transmission/reception points (TRPs).

In one embodiment, the CU transmits requests for establishing TA to multiple candidate DU(s), one per target candidate cell. In one embodiment, the CU transmits requests for establishing TA for a set of target candidate cells in the same candidate DU.

In one embodiment, the CU further includes in the request to the candidate DU, the beam measurement information associated to a requested target candidate cell (e.g., beam measurements for one or more SSB of a requested target candidate cell of the candidate DU). That enables the candidate DU to generate an uplink configuration based on that beam measurement information, e.g. PRACH preambles mapped to one or more SSB(s) reported as good enough/suitable in terms of RSRP and/or RSRQ and/or SINR.

In one embodiment, the request message from the CU to the candidate DU may correspond to a UE Context Setup Request (F1AP message).

In one embodiment, the request for the establishment of the TA between the UE and the least one of its target candidate cell(s) is an indication (encoded as an information element (IE)) in a UE Context Setup Request (F1AP message).

In one embodiment, the request message from the CU to the candidate DU may correspond to a UE Context Modification Request (F1AP message), e.g. when the candidate DU is the same as the serving DU.

In one embodiment, the request for the establishment of the TA between the UE and the least one of its target candidate cell(s) is an indication (encoded as an IE) in a UE Context Modification Request (F1AP message), e.g. when the candidate DU is the same as the serving DU.

In one set of embodiments, when the CU determines to configure L1/L2 inter-cell mobility for at least one target candidate cell in a candidate DU, this represents for the candidate DU an implicit request that a TA establishment is needed. The candidate DU then determines by itself whether to provide one TA that is valid for all the L1/L2 inter-cell mobility target candidate cells that is configuring or one TA for each of the L1/L2 inter-cell mobility target candidate cell.

In one set of embodiments, the candidate DU accepts the request for configuring L1/L2 inter-cell mobility (for at least one target candidate cell) and accepts the request to establish TA for at least one target candidate cell (or a plurality of target candidate cells). In that case, the Candidate DU responds to the request from the CU with a response message including the target candidate configuration (e.g., for target candidate cell X), and including an uplink configuration for establishing the TA between the UE and the target candidate cell (e.g., target candidate cell X). The UE later receives that uplink configuration.

In one embodiment, the response message also includes an indication that TA establishment has been accepted by the candidate DU, e.g., an indication as an IE of the F1AP message, in addition to the uplink configuration. This may be used so the serving DU does not have to parse RRC fields in the response message to find the uplink configuration and determine the acceptance for the TA establishment. The serving DU may use that when the triggering of the TA establishment later leads to a message from the candidate DU to the serving DU (via the CU) with the TA value.

In one embodiment, the response from the candidate DU may correspond to a UE Context Setup Response (F1AP message).

In one embodiment, the response from the candidate DU (e.g., step 2b of FIG. 7) may correspond to a UE Context Modification Response (F1AP message), e.g., when the candidate DU is the serving DU, which may be the case when a requested target candidate cell is in the serving DU.

Further details about the uplink configuration for establishing the TA between the UE and the target candidate cell are provided in later steps when the UE receives the uplink configuration.

In one set of embodiments, the candidate DU accepts the request for configuring L1/L2 inter-cell mobility (for at least one target candidate cell) but rejects the request to establish TA for at least one target candidate cell (or a plurality of target candidate cells). In that case, the candidate DU responds to the request from the CU with a response message including the target candidate configuration (e.g., for target candidate cell X). That may possibly include an indication of the reject of TA establishment, wherein the indication may comprise the inclusion or absence of a parameter or configuration in the response message (e.g., absence of an F1AP IE, or presence). In this scenario the serving DU becomes aware that if L1/L2 inter-cell mobility is to be executed to that target candidate cell, random access may be required with the target candidate during the execution for establishing the TA/UL synchronization.

In one set of embodiments, the candidate DU rejects the request for configuring L1/L2 inter-cell mobility and transmits to the CU a message indicating the rejection, which may optionally include a cause value e.g. overload.

In one set of embodiments, the candidate DU requests the establishment of a TA for the UE and a target candidate cell for L1/L2 inter-cell mobility (for at least one target candidate cell). In that case, the candidate DU responds the request from the CU for L1/L2 inter-cell mobility with a response message including the target candidate configuration (e.g., for target candidate cell X), and including an uplink configuration for establishing the TA between the UE and the target candidate cell (e.g., target candidate cell X), which may serve as an indication that the candidate DU is requesting the TA establishment between the UE and one or more of its target candidate cell(s). The UE later receives the uplink configuration.

The following steps may be used for including re-configuration(s) in the serving cell(s) by the serving DU before the UE is configured with L1/L2 inter-cell mobility, e.g., to re-configure CSI measurements. In that case, the CU generates an RRC Reconfiguration (e.g., RRCReconfiguration) message including a Cell Group Configuration generated by the serving DU (e.g., step 4a of FIG. 7). The CU also includes the L1/L2 inter-cell mobility configuration with one or more target candidate cell configuration(s) and the necessary configuration for the UE to establish the TA with one or more target candidate cells for L1/L2 inter-cell mobility.

In one set of embodiments, the UE receives an RRCReconfiguration message (e.g. from the CU via serving DU), configuring L1/L2 inter-cell mobility, the message including a L1/L2 inter-cell mobility configuration configuring one or more target candidate cells for L1/L2 inter-cell mobility, i.e., the L1/L2 inter-cell mobility configuration including one or more target candidate cell configuration(s), and an uplink configuration for establishing the TA between the UE and the target candidate cell (e.g., target candidate cell X), as described above.

In one embodiment, the UE receives an uplink configuration for establishing the TA for a target candidate cell.

In one embodiment, the UE receives multiple UL configuration(s) for establishing the TA for multiple target candidate cell(s), one per target candidate cell.

In one embodiment, the UE receives an indication associated to a target candidate cell, to indicate that this is a cell for which the UE shall establish TA, e.g., by transmitting an uplink signal. The UE may have received at least one uplink configuration for each target candidate cell for which it shall establish TA, based on which the UE transmits a message to the target candidate cell.

In one embodiment, the target candidate cells the UE is configured with, for which the UE establishes TA, comprises a subset of the target candidate cells for L1/L2 inter-cell mobility. In other words, the UE may be configured with a number ‘N’ of L1/L2 inter-cell mobility candidates and is configured to establish TA with a number ‘N1’ (with N1<N) candidate cells. The reason may be that some target candidate cells may not require TA to be established, e.g., if they are in the same serving DU and/or are synchronized with one or more serving cells, and/or some of these candidate cells are co-located with one or more of the other serving cell(s), so that the same TA value may be assumed (i.e., some target candidate cells may be assumed to be UL synchronized with the UE).

In one embodiment, the UE receives an indication of a target candidate cell for which the UE does not need to establish TA and, in addition, the UE receives an indication that for the candidate cell the UE may assume the same TA value used for a given serving cell. For example, the UE receives associated to the target cell configuration a serving cell index of one of its configured serving cells. Then, when the UE receives the L1/L2 inter-cell mobility execution command (e.g., MAC CE indicating a target candidate cell) the UE determines that this is a cell for which TA value to be considered is the same as the TA value for the indicated serving cell, and the UE applies that TA value accordingly when accessing the target candidate cell.

In one embodiment, the UE receives an indication of a target candidate cell for which the UE does not need to establish TA and, in addition, the UE receives a TA value for the candidate cell. For example, the UE receives associated to the target cell configuration a serving cell index of one of its configured serving cells. Then, when the UE receives the L1/L2 inter-cell mobility execution command (e.g., MAC CE indicating a target candidate cell) the UE applies that TA value provided in the L1/L2 inter-cell mobility execution command.

In a related embodiment, the UE receives an indication of a target candidate cell for which the UE does not need to establish TA and, in addition, the UE receives the TA value 0 for the candidate cell. For example, the UE receives associated to the target cell configuration a serving cell index of one of its configured serving cells. Then, when the UE receives the L1/L2 inter-cell mobility execution command (e.g., MAC CE indicating a target candidate cell) the UE applies that TA value 0 provided in the L1/L2 inter-cell mobility execution command.

In one embodiment, the UE receives an indication of a target candidate cell for which the UE does not need to establish TA (e.g., absence of the uplink configuration for TA establishment or an explicit indication in the target candidate cell configuration) and, in addition, the UE receives an indication that for the candidate cell the UE may require random access with the target candidate upon reception of the L1/L2 inter-cell mobility execution command (e.g., MAC CE indicating a target candidate cell).

In one embodiment, the UE receives the uplink configuration for establishing the TA between the UE and the target candidate cell (e.g., target candidate cell X) which may comprise an indication (e.g., an uplink configuration for a target candidate cell) based on which the UE transmits an uplink signal or message to the target candidate cell (e.g., a PRACH preamble), enabling the candidate DU to establish the TA and to indicate the TA value to the CU and the serving DU.

In one embodiment, the UE receives the uplink configuration for establishing the TA between the UE and the target candidate cell (e.g., target candidate cell X) (e.g. as a field, parameter, set of parameters and/or fields, IE, etc.) within the target candidate configuration (e.g., for target candidate cell X, in an RRCReconfiguration container, and/or an IE CellGroupConfig and/or an SpCell configuration). That may be, e.g., one or more parameters in a random access configuration of the SpCell configuration in the target candidate configuration.

In one embodiment, the UE receives the uplink configuration for establishing the TA between the UE and the target candidate cell (e.g., target candidate cell X) configured as an IE and/or field and/or set of IEs and fields in the L1/L2 inter-cell mobility configuration, which may correspond to an IE for configuring one or more target candidate cell(s) for L1/L2 inter-cell mobility.

In one option the uplink configuration is set for a target candidate cell, e.g., a target candidate cell has its uplink configuration for TA establishment. In one option the uplink configuration is set for a set of target candidate cell(s). The uplink configuration may still be for a given target candidate cell, as the parameters are defined for a given uplink channel of a given cell, but when the UE establishes TA for that single cell, it is valid for a set of cells, which applies if multiple cells are of the same candidate DU and/or the same TRP and/or have some common transceiver properties and/or are uplink synchronized.

In one embodiment, the UE receives the uplink configuration for establishing the TA between the UE and the target candidate cell (e.g., target candidate cell X) configured as an IE and/or field and/or set of IEs and fields in the RRC Reconfiguration message in which the UE receives the L1/L2 inter-cell mobility configuration.

In one embodiment, the UE receives the uplink configuration for establishing TA between the UE and the target candidate cell (e.g., target candidate cell X) comprising the configuration of an uplink signal/message and/or the configuration of the channel(s) for the UE to transmit the uplink signal/message (to be received at the candidate DU).

The uplink signal/message may correspond to a random-access preamble (or an equivalent sequence defined in the physical layer) indicated by a random access preamble index (e.g., ra-PreambleIndex of IE INTEGER (0 . . . 63)) in the uplink configuration.

The uplink configuration may further include at least one beam identifier/index associated to an uplink signal, such as an SSB index and/or a CSI-RS resource identifier.

For example, when the uplink signal corresponds to a preamble, the uplink configuration may comprise at least one TA establishment resource, as the pair (ssb of IE SSB-Index, ra-PreambleIndex or IE INTEGER (0 . . . 63)). The uplink configuration may comprise multiple of these pairs, as the candidate DU is not aware which SSB and/or CSI-RS resource the UE would choose for establishing the TA. The configured beam(s), e.g. SSBs, may be referred to as candidate beams for TA establishment.

In the example below, the UE is provided with a list of TA establishment resource(s) for a target candidate cell, wherein each resource has a preamble index and an SSB index associated:

| | |
|---|---|
| TA-Config ::= | SEQUENCE { |

[...]

| | |
|---|---|
| candidateBeamList | SEQUENCE (SIZE(1..FFS)) OF TA-SSB-Resource OPTIONAL, |

[...]
}
[...]

| | |
|---|---|
| TA-SSB-Resource ::= | SEQUENCE { |
| ssb | SSB-Index, |
| ra-PreambleIndex | INTEGER (0..63), |

...
}

In another example, the UE is provided with a list of TA establishment resource(s) for a target candidate cell, wherein each resource has a preamble index and a CSI-RS resource associated. In addition to the pair, there is also per resource a random-access occasion list. These are RA occasions that the UE shall use when performing TA establishment with a target candidate cell upon selecting the candidate beam identified by the corresponding CSI-RS.

| | |
|---|---|
| TA-CSI-Resource ::= | SEQUENCE { |
| csi-RS | NZP-CSI-RS-ResourceId, |
| ra-PreambleIndex | INTEGER (0..63) |

OPTIONAL, -- Need R

| | |
|---|---|
| ra-OccasionList | SEQUENCE (SIZE (1..maxRA-OccasionsPerCSIRS)) OF INTEGER |

```
  (0..maxRA-Occasions-1) OPTIONAL, -- Need R
    ...
  }
```

The candidate DU determines which beam identifier(s)/indexes of a target candidate cell to configure for TA establishment based on beam measurement information (e.g., measurement information on SSBs and/or CSI-RS of a target candidate cell) obtained from the CU in/with the request of L1/L2 inter-cell mobility. The network (e.g., CU) may have configured the UE to report beam measurement information as it intended to trigger the UE to establish TA with a target candidate when it configures the UE with L1/L2 inter-cell mobility. For example, for a neighbor cell included in the measurement report, the UE may have reported SSB index X and SSB index Y and their respective RSRP values (e.g., above a threshold in the reporting configuration) indicating these are suitable beams in the neighbor cell.

The uplink configuration may further include one or more of the following parameters:

Root Sequence Index: PRACH root sequence index for TA establishment in L1/L2 inter-cell mobility, which may be defined in TS 38.211. This may be a field, e.g. rootSequenceIndex of IE INTEGER (0 . . . 137)).

RSRP threshold for SSB: L1-RSRP threshold used for determining whether a candidate beam may be used by the UE to attempt contention free random access to establish TA with a target candidate cell. This may be a field rsrp-ThresholdSSB.

SSB(s) per RACH occasion(s): Number of SSBs per RACH occasion for contention free TA establishment with a target candidate cell. This may be the field ssb-perRACH-Occasion of IE ENUMERATED {oneEighth, oneFourth, oneHalf, one, two, four, eight, sixteen}.

RA SSB occasion mask index: Explicitly signaled PRACH Mask Index for RA Resource selection, valid for one or more SSB resources. This may be the field ra-ssb-OccasionMaskIndex.

Subcarrier spacing for MSG1: Subcarrier spacing for contention free TA establishment with the target candidate cell, e.g. values 15 kHz or 30 kHz (FR1), and 60 kHz or 120 kHz (FR2). This may be the parameter msg1-SubcarrierSpacing of IE SubcarrierSpacing.

A triggering condition in the form of a measurement event A2, A3, A4 or A5 that is to be fulfilled before triggering TA establishment with a target candidate cell.

The uplink configuration may correspond to contention-free resource and/or dedicated resources, so that when the candidate DU receives a preamble in an uplink slot in a frequency resource it is able to determine which UE this has been configured for and/or which serving DU/CU is serving the UE.

The uplink configuration may further include one or more parameters of a random access configuration, such as RACH parameters such as preamble(s), time and frequency resources for a PRACH, and/or one or more parameters, fields and/or IEs within the IE RACH-Config, RACH-ConfigCommon, RACH-ConfigDedicated, RACH-ConfigGeneric as defined in TS 38.331. This may be special RACH configuration containing only the transmission parameters, i.e., no random access response parameters, because the UE is not expected to receive a response from the target candidate in response to the preamble transmission.

In one embodiment, the UE receives the uplink configuration for establishing TA between the UE and the target candidate cell (e.g., target candidate cell X) comprised within one or more parameters in the beam failure recovery (BFR) configuration of the target candidate cell (e.g., IE BeamFailureRecoveryConfig) associated to the uplink bandwidth part (BWP) that may be assumed active upon L1/L2 inter-cell mobility execution. Using that, the candidate DU may distinguish preambles and RACH message for the TA establishment from other preambles and RACH attempts. BFR is anyways not used for the UE before the target candidate is accessed during L1/L2 inter-cell mobility execution, which facilitates this without the need of a further detailed configuration.

In one embodiment, the UE obtains the uplink configuration, at least partially, from a random access configuration of the target candidate configuration, e.g., the RACH configuration of the SpCell configuration of the target candidate configuration. The UE may receive a time/frequency resource partitioning for PRACH and/or a preamble partitioning indicating a subset of RACH resource used for that purpose, so that the candidate DU is aware that a preamble transmitted shall not be responded in a RAR, but the TA shall be calculated and provided to a serving DU. In that sense, the candidate DU may provide different PRACH resource partitioning for UE(s) in different serving DU(s), for multiple requests.

In one set of embodiments, the UE receives an RRCReconfiguration message (e.g., from the CU via serving DU), the message including an uplink configuration for establishing the TA between the UE and the target candidate cell (e.g., target candidate cell X) only after the UE has received a L1/L2 inter-cell mobility configuration configuring one or more target candidate cells for L1/L2 inter-cell mobility, i.e., the L1/L2 inter-cell mobility configuration including one or more target candidate cell configuration(s). This means that the CU or serving DU may request the establishment of the TA to the candidate DU only after they decided that L1/L2 inter-cell mobility shall be executed toward that candidate DU. This also means that the uplink configuration is received by the serving DU before sending the lower layer switching command to the UE for executing the L1/L2 inter-cell mobility.

In a set of embodiments, the UE transmits an uplink signal (e.g., PRACH preamble) to a target candidate cell for which it shall establish TA, based on the uplink configuration described above (e.g. step 5 of FIG. 7).

In one set of embodiments, the UE transmits the uplink signal in response to the reception of the RRCReconfiguration configuring L1/L2 inter-cell mobility including the indication for TA establishment for that target candidate cell.

In one set of embodiments, what triggers the UE to transmit the uplink signal to the target candidate cell is a subsequent message (e.g. MAC CE, PDCCH order, DCI, RRC message) received by the UE after the RRCReconfiguration configuring L1/L2 inter-cell mobility including the indication for TA establishment for that target candidate cell. A scenario in which this may be useful is a scenario where the candidate DU accepts the TA establishment from the CU, but the serving DU has some freedom to trigger the TA establishment to the UE when an interruption time would not be so critical, because to transmit the uplink signal to the target candidate the UE may need to stop listening to the serving cell(s)/serving DU. Upon reception of the subsequent message, the UE transmits the uplink signal/message based on the previously received uplink configuration for the TA establishment in L1/L2 inter-cell mobility preparation. This scheme may also be used for the TA update/maintenance mechanism, described in the following sections.

In one embodiment, the uplink configuration is associated to a validity time, so that the serving DU and/or the CU has a limited time to trigger the subsequent message. That may be used to limit the uplink resources reserved for TA establishment, e.g. if they are UE dedicated/contention-free resources.

In one embodiment, upon triggering the TA establishment with a target candidate, the UE initiates a procedure which comprises one or more of the following steps:
Performing one or more measurements on SSBs and/or CSI-RS resources of the target candidate cell for which the UE shall establish the TA;
Performing an uplink channel resource selection, e.g. RACH resource selection, associated to an SSB and/or CSI-RS resource of the target candidate cell for which the UE shall establish the TA. For example, the UE selects an SSB or CSI-RS resource for which a measurement is above a threshold (potentially configured in the uplink configuration), e.g. SSB RSRP>rsrp-ThresholdSSB; and the UE selects an uplink channel resource (e.g., time/frequency resources and preamble) for TA establishment associated to the selected SSB, wherein the association is also part of the uplink configuration.
Transmitting the uplink signal/message (e.g., preamble) in the selected resource.

In a set of embodiments, the candidate DU receives at least one uplink signal (e.g., a PRACH preamble), in an uplink channel (PRACH time/frequency resource slot) allocated for the purpose of TA establishment for L1/L2 inter-cell mobility, calculates a TA value valid for a UE and at least one target candidate cell. The candidate DU transmits a message to the CU comprising the at least one TA value (e.g., step 6A in FIG. 7).

In one embodiment, the candidate DU transmits the message to the CU comprising a TA value and one or more associated target candidate cell(s) for which the TA value is applicable. Using that information, the CU (and possibly the serving DU, also receiving that information) would know that a given TA value is applicable to one or more target candidate cell(s) the UE is configured with, which may be needed during L1/L2 inter-cell mobility execution to one of these candidate cells.

In one embodiment, the candidate DU transmits the message to the CU using a UE signaling connection, so that the CU is aware that a TA value associated to a target candidate cell corresponds to the UE for that UE signaling connection.

In one embodiment, when the candidate DU transmits the message to the CU the candidate DU starts a timer (which may be referred to as a TA timer), and while the timer is running the candidate DU considers the TA value that it has provided to the CU as “valid”, which means that while the timer is running the candidate DU may receive the incoming UE with L1/L2 inter-cell mobility without random access, as TA is valid, assuming the TA value is provided to the UE via CU and/or serving DU. When the timer expires the candidate DU considers the TA value as “not valid” and, when the TA value is not valid, the candidate DU may trigger a TA update procedure.

In one embodiment, the CU receives the message including the TA value associated to a target candidate cell and a UE configured for L1/L2 inter-cell mobility and the CU starts a timer. While the timer is running the CU considers the TA value as “valid”; when the timer expires the CU considers the TA value as “not valid”. When the TA value is not valid, the CU may trigger an TA update procedure.

In one option, the candidate DU further includes in the message to the CU the timer value (e.g., a TA timer) associated to a TA value (applicable for at least one target candidate cell), wherein the TA value is considered “valid” while the timer is running, and not valid when the timer expires. In that case, the candidate DU may also start a timer with the same or similar value, so that it may also be aware when the TA value is not valid for the UE and the target candidate cell.

In one embodiment, the uplink signal and/or resource may have been configured for a specific UE (e.g., per UE resource, contention-free preamble and/or PRACH resources for TA establishment), so that at the reception the candidate DU knows to which UE this is associated, and consequently to which CU this is associated, as for that UE there is a UE-signaling connection (as that is a UE for which the candidate DU has accepted the request for configuring L1/L2 inter-cell mobility).

The candidate DU, based on the received signal, calculates the TA value for that UE and the target candidate cell, and transmits that value to the serving DU (via the CU), to be used by the UE in the L1/L2 inter-cell mobility execution (at a later moment) (e.g., step 6b of FIG. 7).

In one set of embodiments, the CU transmits a message to the serving DU in which the UE is connected, including the at least one TA value. The candidate DU receives at least one uplink signal (e.g., a PRACH preamble), in an uplink channel (PRACH time/frequency resource slot) allocated for the purpose of TA establishment for L1/L2 inter-cell mobility, calculates a TA value, valid for a UE and at least one target candidate cell, and the candidate DU transmits a message to the CU comprising the at least one TA value, so that the CU transmits to the serving DU.

In one embodiment, the serving DU receives the message from the CU comprising a TA value and one or more associated target candidate cell(s) for which the TA value is applicable. The serving DU knows that a given TA value is applicable to one or more target candidate cell(s) the UE is configured with, which may be needed during L1/L2 inter-cell mobility execution to one of these candidate cells.

In one embodiment, the serving DU receives the message from the CU in a UE signaling connection, so that the serving DU is aware that a TA value associated to a target candidate cell corresponds to the UE for that UE signaling connection.

In one embodiment, the serving DU receives the message including the TA value associated to a target candidate cell and a UE configured for L1/L2 inter-cell mobility and the serving DU starts a timer (which may be referred to as a TA timer). While the timer is running the serving DU considers the TA value as “valid”; when the timer expires the serving DU considers the TA value as “not valid”. When the TA value is not valid, the serving DU may trigger an TA update procedure.

In one option, the serving DU receives in the message from the CU the timer value (e.g., a TA timer) associated to a TA value (applicable for at least one target candidate cell), wherein the TA value is considered “valid” while the timer is running, and not valid when the timer expires. In that case, the candidate DU and/or the CU may also start a timer with the same or similar value, so that it may also be aware when the TA value is not valid for that UE and the target candidate cell.

In a set of embodiments, the UE may transmit measurements to assist the serving DU and/or the candidate DU and/or the CU to trigger the L1/L2 inter-cell mobility execution, e.g., including CSI measurements for a target candidate cell for L1/L2 inter-cell mobility for which the UE has triggered the establishment of the TA (e.g., step 7 of FIG. 7).

In response to the reported measurements (L1 RSRP) for a given target candidate cell, the network (e.g., the serving DU) may determine to trigger L1/L2 inter-cell mobility execution for the UE to the target candidate cell for which the UE has triggered the establishment of the TA (e.g., step 8 of FIG. 7).

In one embodiment, the serving DU performs one or more of the following actions. If the target candidate cell (e.g., cell X) for which the serving DU determines to trigger L1/L2 inter-cell mobility execution is a cell for which the serving DU has a valid TA value (e.g., TA timer is running) for the UE and that target candidate cell, then the serving DU transmits to the UE a lower layer signaling (e.g., MAC CE) indicating that target candidate cell for L1/L2 inter-cell mobility and includes the TA value to be applied by the UE for communication with the target candidate cell. If the target candidate cell (e.g., cell X) for which the serving DU determines to trigger L1/L2 inter-cell mobility execution is a cell for which the serving DU has a not valid TA value (e.g., TA timer has expired) for the UE and that target candidate cell, the serving DU transmits to the UE a lower layer signaling (e.g., MAC CE) indicating that target candidate cell for L1/L2 inter-cell mobility not including the TA value.

In one embodiment, the serving DU performs one or more of the following actions. If the TA timer is running, the network (e.g. serving DU) transmits to the UE a lower layer signaling (e.g., MAC CE) indicating that target candidate cell for L1/L2 inter-cell mobility and includes the TA value. If the TA timer had expired or stopped, the network (e.g., serving DU) transmits to the UE a lower layer signaling (e.g., MAC CE) indicating that target candidate cell for L1/L2 inter-cell mobility not including the TA value.

In one embodiment, the serving DU performs one or more of the following actions. If the target candidate cell (e.g., cell X) for which the serving DU determines to trigger L1/L2 inter-cell mobility execution is a cell for which the serving DU has a valid TA value (e.g., TA timer is running) for the UE and that target candidate cell which is the same as the TA value for a serving cell the UE is configured with, then the serving DU transmits to the UE a lower layer signaling (e.g., MAC CE) indicating that target candidate cell for L1/L2 inter-cell mobility and includes that TA value for that serving cell the UE is configured with and to be applied by the UE for communication with the target candidate cell.

Another alternative is that instead of providing the TA value, the serving DU provides a serving cell index, indicating to the UE that the UE shall use the TA value between the UE and the serving cell whose index has been indicated as the TA value for the UE and the target candidate cell, also indicated in the lower layer signaling.

The UE receives the lower layer signaling (e.g., MAC CE) indicating that target candidate cell for L1/L2 inter-cell mobility and, if the signaling includes the TA value, the UE applies that TA value for the target candidate cell (for UL transmissions). If the signaling does not include the TA value or the indicated target candidate cell is a cell for which TA is the same as a serving cell (and the UE is aware of that based on the target candidate configuration), the UE applies that TA value of the associated serving cell for that target candidate cell (for uplink transmissions). If the signaling does not include the TA value or the indicated target candidate cell is a cell for which TA has not been established, the UE performs random access to the target candidate cell indicated.

If the signaling includes a serving cell index, the UE uses the TA value between the UE and the serving cell whose index has been indicated as the TA value for the UE and the target candidate cell, also indicated in the lower layer signaling.

The UE transmits the uplink message to the target candidate after having applied the indicated TA value for the target candidate cell according to the method (e.g., step 9 of FIG. 7).

Some embodiments include TA maintenance/updates for target candidate cell(s) for L1/L2 inter-cell mobility. Some embodiments include CU-initiated TA update.

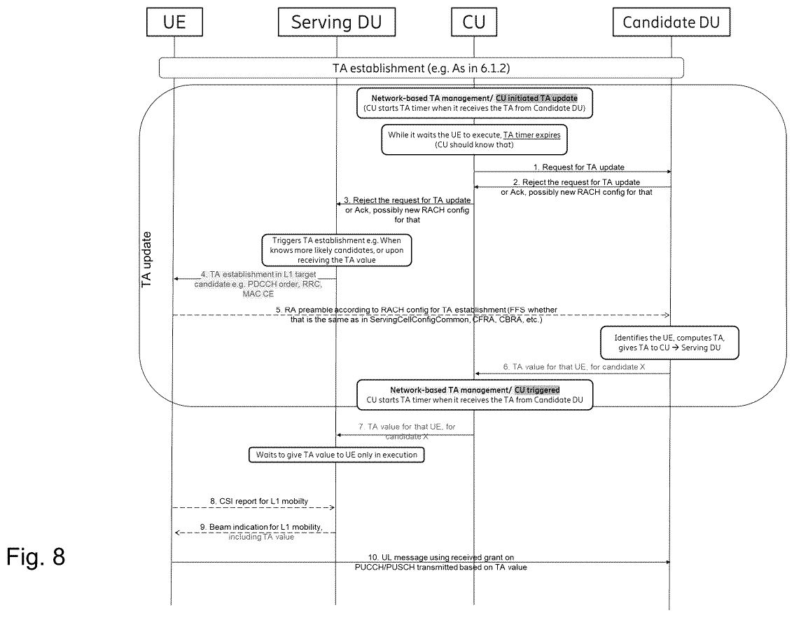

FIG. 8 is a signaling diagram illustrating an example of TA re-establishment/update with target candidate cell(s). In one set of embodiments, the TA value for a target candidate cell is managed by the CU. When the CU receives a TA value for a UE and at least one target candidate cell configured for L1/L2 inter-cell mobility, the CU starts an associated timer (referred to as TA timer), whose value may have been received from the candidate DU.

In a set of embodiments, when the CU determines that the TA value for a UE and a target candidate cell configured for L1/L2 inter-cell mobility is not valid, e.g., by the expiry of the TA timer, the CU performs one or more of the following actions.

In one embodiment, the CU transmits a message with a TA re-establishment request (or TA update) to the candidate DU associated to the target candidate cell for which the TA timer has expired (e.g. step 1 of FIG. 8). In one option, the message is sent on a UE-signaling connection to indicate this is for a given UE and may include one or more target candidate cell(s) associated to that receiving candidate DU. In one option, the message is a UE Context Modification Request, including an indication that the TA value previously provided is not valid.

In one option, the TA re-establishment request is similar to the TA establishment request, e.g. same IE, as a request for new uplink configuration(s) and/or uplink resources to the UE to establish TA, as described above. One difference may be that the initial TA establishment was indicated in a UE Context Setup Request, which also included the request for configuring a target candidate cell for L1/L2 inter-cell mobility, while now that cell has already been configured, so that the request is included in a UE Context Modification Request message.

In one option, the TA re-establishment uses the same procedure used for modifying a L1/L2 inter-cell mobility configuration of a target candidate cell associated to the candidate DU.

In one option, the TA re-establishment includes an indication of the target candidate cell (and/or the target candidate cell configuration, e.g., a configuration ID) associated to the TA value previously configured.

In one embodiment, the message includes beam measurement information, which may be used by the candidate DU to configure UE dedicated uplink configuration (e.g., contention free RACH resources) for the transmission of an uplink signal for TA establishment between the UE and a target candidate cell. The beam measurement information may be equivalent to the one disclosed above, like based on RRC measurement reports, and/or measurement information obtained from CSI reports to the serving DU, made available to the CU.

In one embodiment, the candidate DU accepts the request for the TA re-establishment and transmits a response message including an uplink configuration to be used by the UE for re-establishing the TA (similar to the ones disclosed above) (e.g., step 2 of FIG. 8).

In one embodiment, the candidate DU accepts the request for the TA re-establishment and transmits a response message including an authorization for the UE to use the previous provided uplink configuration, to be used by the UE for re-establishing the TA. In other words, in this case there is no need to provide a new uplink configuration, but the response is a confirmation that the previous provided uplink configuration may be used.

In a set of embodiments, the candidate DU accepts the request for the TA update/re-establishment for at least one target candidate cell (or a plurality of target candidate cells). The candidate DU responds the request from the CU with a response message (which may be referred to as an acknowledgement (ACK)).

In one embodiment, the response from the candidate DU to the CU includes an uplink configuration for re-establishing/updating the TA between the UE and the target candidate cell (e.g., target candidate cell X). The may UE later receive the uplink configuration.

In one embodiment, the response from the candidate DU to the CU does not include an uplink configuration for re-establishing/updating the TA between the UE and the target candidate cell (e.g., target candidate cell X), but it includes an indication that the TA between the UE and a target candidate cell may be re-established/updated based on the previously configured uplink configuration.

In one embodiment, the response message also includes an indication that TA establishment has been accepted by the candidate DU, e.g. an indication as an IE of the F1AP message, in addition to the uplink configuration. That may be used so the serving DU does not need to parse RRC fields in the response message to find the uplink configuration and determine the acceptance for the TA establishment. The serving DU may use that when the triggering of the TA re-establishment/update later leads to a message from the candidate DU to the serving DU (via the CU) with the TA value.

In one embodiment, the response from the candidate DU may correspond to a UE Context Modification Response (F1AP message). The candidate DU may correspond to a Neighbor DU or to the Serving DU, which may be the case when a requested target candidate cell is in the serving DU.

In a set of embodiments, the details about the uplink configuration for re-establishing the TA between the UE and the target candidate cell are similar to the uplink configuration for the establishment of the TA between the UE and the target candidate cell, except that the values set to the fields and/or IEs and/or parameters may differ.

In a set of embodiments, the candidate DU responds with a pointer to the previously configured uplink configuration, provided during the TA establishment to the UE.

In one set of embodiments, the candidate DU rejects the request to re-establish/update TA for at least one target candidate cell (or a plurality of target candidate cells). In that case, the candidate DU responds the request from the CU with a response message including an indication of the reject of TA re-establishment/update, wherein the indication may comprise the inclusion or absence of a parameter or configuration in the response message (e.g., absence of an F1AP IE, or presence). In this scenario the serving DU becomes aware that if L1/L2 inter-cell mobility is to be executed to that target candidate cell, random access may be required with the target candidate during the execution for establishing the TA/UL synchronization.

In a set of embodiments, the CU transmits to the serving DU information which it has received in a previous step from the candidate DU regarding the TA re-establishment/update between the UE and a target candidate cell configured for L1/L2 inter-cell mobility. The information is provided so that the serving DU may trigger the UE to initiate the TA re-establishment/update with a target candidate cell, potentially using a previously stored uplink configuration. The serving DU may provide to the UE a message (e.g., a MAC CE, a PDCCH order, a TA re-establishment command, etc.) including an indication enabling the UE to determine an uplink configuration and a target candidate cell to re-establish TA, based on which the UE transmits an uplink signal to the indicated target candidate cell. This may correspond to the subsequent message from the serving DU to the UE which triggers the TA re-establishment to a target candidate cell.

In a set of embodiments, the CU generates an RRC Reconfiguration message to be provided to the UE, via the serving DU, the message comprising an indication to the UE to re-establish/update the TA with a target candidate configuration, e.g., by including the indication associated to a target candidate cell (e.g., step 3 of FIG. 8).

In one embodiment, the RRC Reconfiguration message is provided to the serving DU in a F1 AP message in an RRC container, and also includes an indication that TA re-establishment has been accepted by the candidate DU, e.g. an indication as an IE of the F1AP message. That may be used so the serving DU does not have to parse RRC fields in the response message to find the uplink configuration and determine the acceptance for the TA establishment. The serving DU may use that when the triggering of the TA re-establishment/update later leads to a message from the candidate DU to the serving DU (via the CU) with the TA value.

In a set of embodiments, the UE receives a message from the serving DU (possibly originated in the CU) based on which the UE re-establishes TA with a target candidate cell (e.g., step 4 of FIG. 8).

In one embodiment the UE receives from the serving DU the message which may correspond to a MAC CE, a PDCCH order, a TA re-establishment command, wherein the message includes an indication enabling the UE to determine an uplink configuration and a target candidate cell to re-establish TA, based on which the UE transmits an uplink signal to the indicated target candidate cell. This may correspond to the subsequent message from the serving DU to the UE that triggers the TA re-establishment to a target candidate cell.

In one embodiment, the UE receives from the CU, via the serving DU, the message which may correspond to an RRC Reconfiguration message. In response to that message, the UE initiates the TA re-establishment/update by transmitting an uplink signal based on an uplink configuration to the indicated target candidate cell.

In one embodiment, that RRC Reconfiguration includes an uplink configuration to the UE for the target candidate cell for which the UE shall re-establish the TA. Before the UE had received an uplink configuration for that cell, for a previous establishment of TA with the same target candidate cell, but that may have been a one-short configuration, so that the new one is used by the UE for the transmission of the uplink message.

In one embodiment, that RRC Reconfiguration does not include an uplink configuration to the UE for the target candidate cell for which the UE shall re-establish the TA, but its absence may indicate that the UE shall use a previously received uplink configuration for that cell for a previous establishment of TA with the same target candidate cell.

In a set of embodiments, the UE transmits an uplink signal (e.g., PRACH preamble) to a target candidate cell for which it shall re-establish TA, based on the uplink configuration described above (e.g., step 5 of FIG. 8).

In one set of embodiments, what triggers the UE to transmit the uplink signal to the target candidate cell is a message as described above, such as a MAC CE, PDCCH order, DCI, RRC message, including the indication for TA re-establishment for that target candidate cell and possibly including at least the target candidate cell for which the UE needs to re-establish the TA, i.e. for which the UE transmits the uplink signal. Upon reception of the message, the UE transmits the uplink signal/message based on a previously received uplink configuration for the TA establishment in L1/L2 inter-cell mobility preparation.

In one embodiment, a previously received uplink configuration is associated to a validity time, so that when the serving DU and/or the CU has a limited time to transmit the message to the UE after it has received the confirmation that the candidate DU has accepted the re-establishment/update of the TA. That may be used to limit the uplink resources reserved for TA establishment, e.g., if these are UE dedicated/contention-free resources.

In one set of embodiments, the UE transmits the uplink signal in response to the reception of the RRCReconfiguration configuring L1/L2 inter-cell mobility including the indication for TA establishment for that target candidate cell and/or an updated uplink configuration.

In one embodiment, upon triggering the TA re-establishment/update with a target candidate cell, the UE initiates a procedure which comprises one or more of the following steps:
Performing one or more measurements on SSBs and/or CSI-RS resources of the target candidate cell for which the UE shall establish the TA;
Performing an uplink channel resource selection, e.g. RACH resource selection, associated to an SSB and/or CSI-RS resource of the target candidate cell for which the UE shall establish the TA. For example, the UE selects an SSB or CSI-RS resource for which a measurement is above a threshold (possibly configured in the uplink configuration), e.g. SSB RSRP>rsrp-ThresholdSSB; and the UE selects an uplink channel resource (e.g., time/frequency resources and preamble) for TA establishment associated to the selected SSB, wherein the association is also part of the uplink configuration.
Transmitting the uplink signal/message (e.g., preamble) in the selected resource.

In a set of embodiments, the candidate DU receives at least one uplink signal (e.g., a PRACH preamble), in an uplink channel (PRACH time/frequency resource slot) allocated for the purpose of TA establishment for L1/L2 inter-cell mobility, calculates a TA value, valid for a UE and at least one target candidate cell. The candidate DU transmits a message to the CU comprising the at least one TA value (e.g., step 6 of FIG. 8).

From that point the steps may be similar to the initial TA establishment.

Some embodiments include candidate DU-initiated TA update.

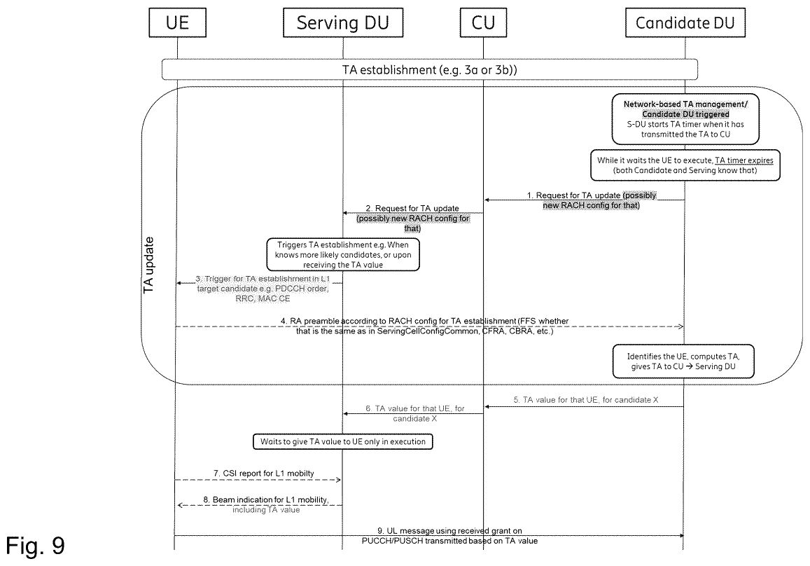

FIG. 9 is a signaling diagram illustrating an example of candidate DU-initiated TA update. In one set of embodiments, the TA value for a target candidate cell is managed by the candidate DU which has configured the target candidate cell. When the candidate DU transmits to the CU (e.g., to be provided the serving DU) the TA value for a UE and at least one target candidate cell configured for L1/L2 inter-cell mobility, the candidate DU starts a timer associated (referred to as a TA timer).

In a set of embodiments, when the candidate DU determines that the TA value for a UE and a target candidate cell configured for L1/L2 inter-cell mobility is not valid, e.g., by the expiry of the TA timer, the candidate DU performs one or more of the following actions. In one embodiment, the candidate DU transmits a message with a TA re-establishment request (or TA update) to the CU, wherein the request is associated to the target candidate cell for which the TA timer has expired (e.g., step 1 of FIG. 9).

In one option, the message is sent on a UE-signaling connection to indicate to the CU that this is for a given UE and may include one or more target candidate cell(s) associated to the transmitting candidate DU.

In one option, the message is a UE Context Modification Required, including an indication that the TA value previously provided is not valid.

In one option, the TA re-establishment uses the same procedure used for modifying a L1/L2 inter-cell mobility configuration of a target candidate cell associated to the candidate DU, wherein the modification is triggered by the candidate DU.

In one option, the TA re-establishment includes an indication of the target candidate cell (and/or the target candidate cell configuration e.g. a configuration ID) associated to the TA value previously configured.

In one embodiment, the candidate DU includes in the request for the TA re-establishment an uplink configuration to be used by the UE for re-establishing the TA (similar to the ones disclosed above).

In one embodiment, the candidate DU in the request for the TA re-establishment includes an authorization for the UE to use the previous provided uplink configuration to be used by the UE for re-establishing the TA. In other words, in this case there is no need to provide a new uplink configuration, but the response is a confirmation that the previous provided uplink configuration may be used.

In a set of embodiments, the candidate DU includes one or more of the following in the request for TA re-establishment: an uplink configuration for re-establishing/updating the TA between the UE and the target candidate cell (e.g., target candidate cell X). The UE may later receive that uplink configuration. The request may not include an uplink configuration for re-establishing/updating the TA between the UE and the target candidate cell (e.g., target candidate cell X), but it includes an indication that the TA between the UE and a target candidate cell may be re-established/updated based on the previously configured uplink configuration.

The request may include an indication allowing TA re-establishment, e.g., an indication as an IE of the F1AP message, in addition to the UL configuration. That may be used so the serving DU does not have to parse RRC fields in the response message to find the uplink configuration and determine the acceptance for the TA establishment. The serving DU may use that when the triggering of the TA re-establishment/update later leads to a message from the candidate DU to the Serving DU (via the CU) with the TA value.

In one embodiment, the request from the candidate DU may correspond to a UE Context Modification Required (F1AP message). The Candidate DU may correspond to a neighbor DU or to the serving DU, which may be the case when a requested target candidate cell is in the serving DU.

In a set of embodiments, the details about the uplink configuration for re-establishing the TA between the UE and the target candidate cell are similar to the uplink configuration for the establishment of the TA between the UE and the target candidate cell, except that the values set to the fields and/or IEs and/or parameters may differ.

In a set of embodiments, the candidate DU includes in the request a pointer to the previously configured uplink configuration, provided during the TA establishment to the UE.

In a set of embodiments, the CU transmits to the serving DU information which it has received in a previous step from the candidate DU, regarding the TA re-establishment/update between the UE and a target candidate cell configured for L1/L2 inter-cell mobility. (e.g., step 2 of FIG. 9). The actions of CU and serving DU form this point onwards may be similar to the actions above for CU-initiated TA update.

Some embodiments include serving DU-initiated TA update.

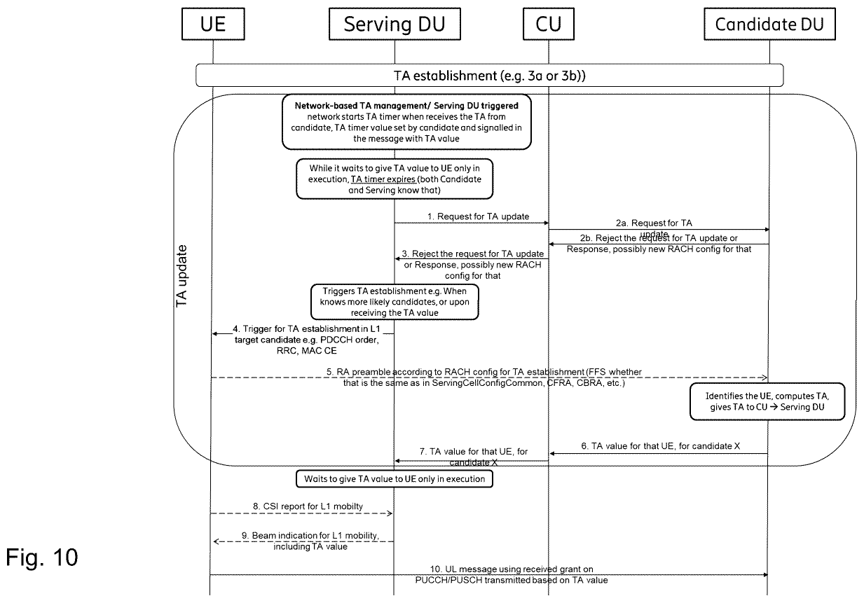

FIG. 10 is a signaling diagram illustrating an example of serving DU-initiated TA update. In one set of embodiments, the TA value for a target candidate cell is managed by the serving DU. When the serving DU receives a TA value for a UE and at least one target candidate cell configured for L1/L2 inter-cell mobility, the serving DU starts a timer associated (referred to as a TA timer), whose value may have been received from the candidate DU.

In a set of embodiments, when the serving DU determines that the TA value for a UE and a target candidate cell configured for L1/L2 inter-cell mobility is not valid, e.g., by the expiry of the TA timer, the serving DU performs one or more of the following actions.

In one embodiment, the serving DU transmits a message with a TA re-establishment request (or TA update) to the CU (to be provided to the candidate DU) associated to the target candidate cell for which the TA timer has expired (e.g., step 1 of FIG. 10).

In one option, the message is sent on a UE-signaling connection to indicate this is for a given UE and may include one or more target candidate cell(s) to indicate to the CU the associated candidate DU which are to be contacted for re-establishing the TA.

In one option, the message is a UE Context Modification Required including an indication that the TA value previously provided is not valid.

In one option, the TA re-establishment request is similar to the TA establishment request, e.g. same IE, as a request for new uplink configuration(s) and/or uplink resources to the UE to establish TA, as disclosed above, in this case if this was a serving DU initiated TA establishment request. The initial TA establishment triggered by the serving DU may be triggered after the serving DU is aware that the UE is being configured with L1/L2 inter-cell mobility with one or more target candidate cells which are not synchronized with that serving DU, e.g. cells associated to a candidate DU.

In one option, the TA re-establishment uses the same procedure used for modifying a L1/L2 inter-cell mobility configuration of a target candidate cell associated to the candidate DU, wherein the modification is triggered by the serving DU.

In one option, the TA re-establishment includes an indication of the target candidate cell (and/or the target candidate cell configuration, e.g. a configuration ID) associated to the TA value previously configured.

In one embodiment, the message includes beam measurement information, which may be used by the CU and/or the candidate DU to configure UE dedicated uplink configuration (e.g., contention free RACH resources) for the transmission of an uplink signal for TA establishment between the UE and a target candidate cell. The beam measurement information may be obtained from CSI reports to the serving DU made available to the CU in the request to be provided to the candidate DU.

When the CU receives the request from the serving DU the procedure is similar to the steps described for the CU-initiated TA update, for example, the CU transmits a request for TA update to the candidate DU (which may accept or reject), as in the steps for CU-initiated TA update.

Some embodiments include UE-based management of TA. In one set of embodiments, the TA value for a target candidate cell is managed by the UE. In one set of embodiments, the UE receives from the CU (e.g., via the serving DU) an RRC Reconfiguration message including the at least one TA value for the UE and at least one target candidate cell. This may be received after the UE has received the RRC Reconfiguration including L1/L2 inter-cell mobility and after the UE has transmitted the uplink signal according to a received uplink configuration to a target candidate cell.

The candidate DU receives at least one uplink signal (e.g., a PRACH preamble) in an uplink channel (PRACH time/frequency resource slot) allocated for the purpose of TA establishment for L1/L2 inter-cell mobility, calculates a TA value, valid for a UE and at least one target candidate cell, and the candidate DU transmits a message to the CU comprising the at least one TA value, so that the CU includes that in an RRC Reconfiguration, transmits to the serving DU, which provides to the UE. Upon reception, the UE starts a TA timer.

At the UE, when the TA timer expires for a given TA value (i.e. for a target candidate cell configured for L1/L2 inter-cell mobility) the UE considers that TA value as not valid, so that if the UE receives a L1/L2 inter-cell mobility command for that target candidate cell, for which the TA value is not valid, the UE triggers random access during the L1/L2 inter-cell mobility execution.

In one embodiment, the TA timer value associated to the TA value is included in the RRC Reconfiguration that includes the TA value.

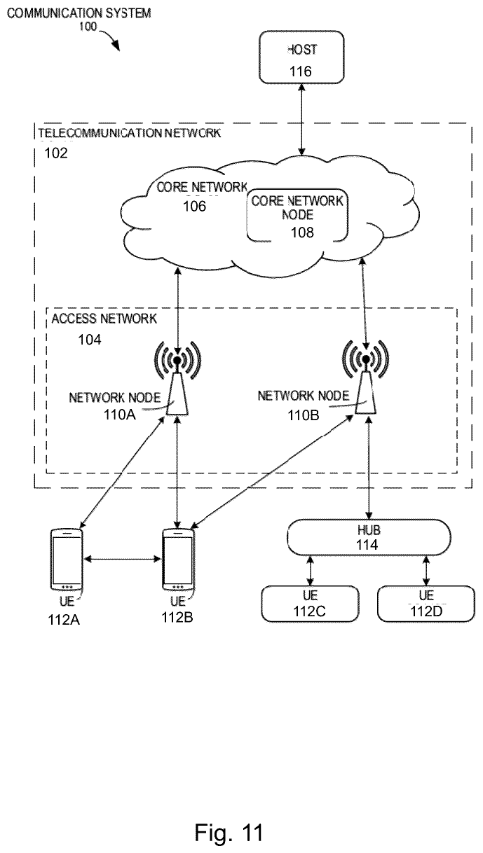

FIG. 11 illustrates an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more services. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

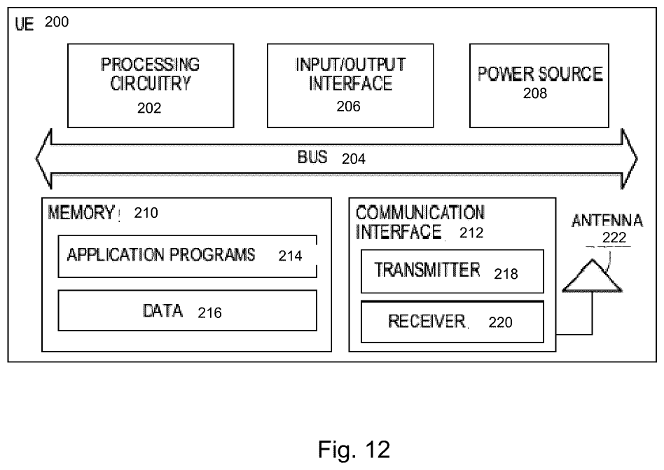

FIG. 12 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

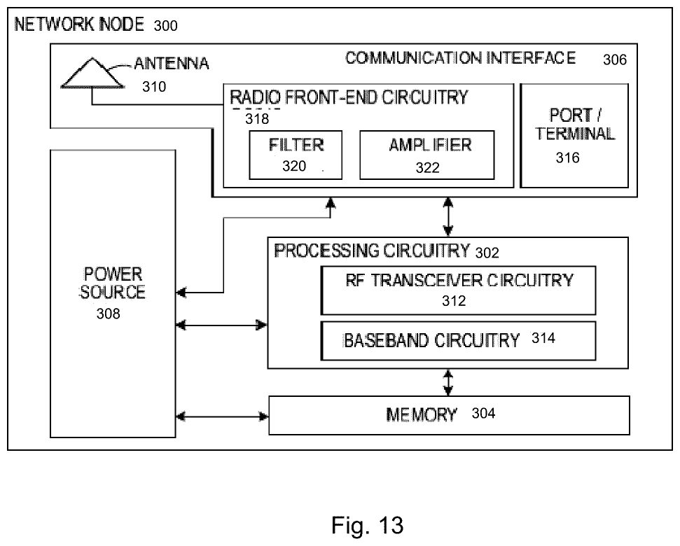

FIG. 13 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 13 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

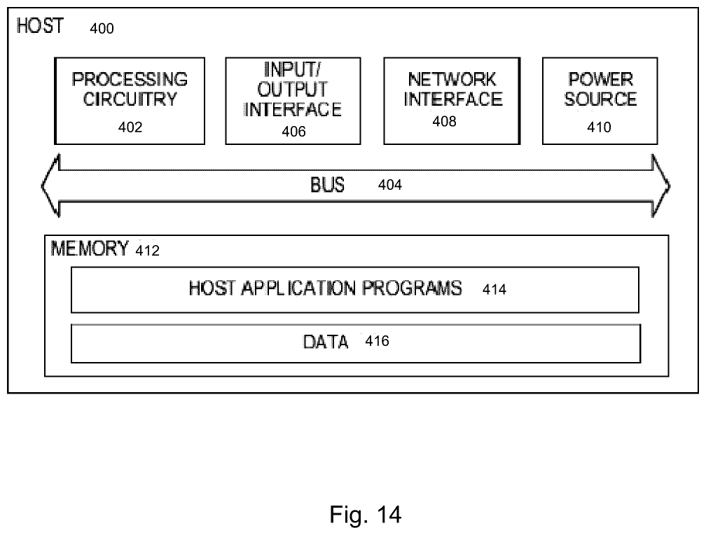

FIG. 14 is a block diagram of a host 400, which may be an embodiment of the host 116 of FIG. 11, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

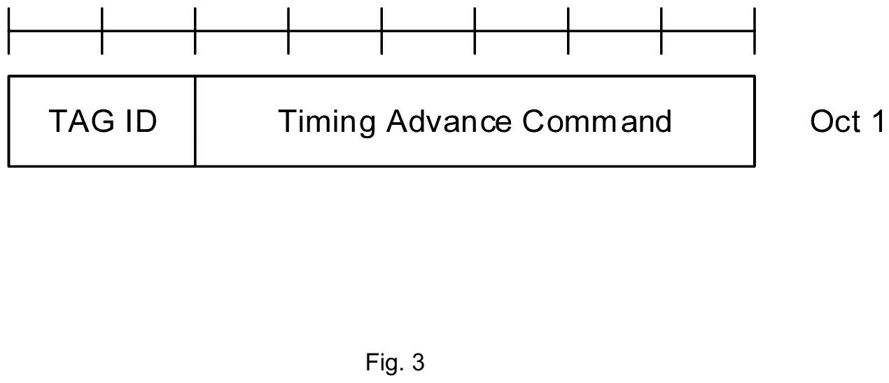

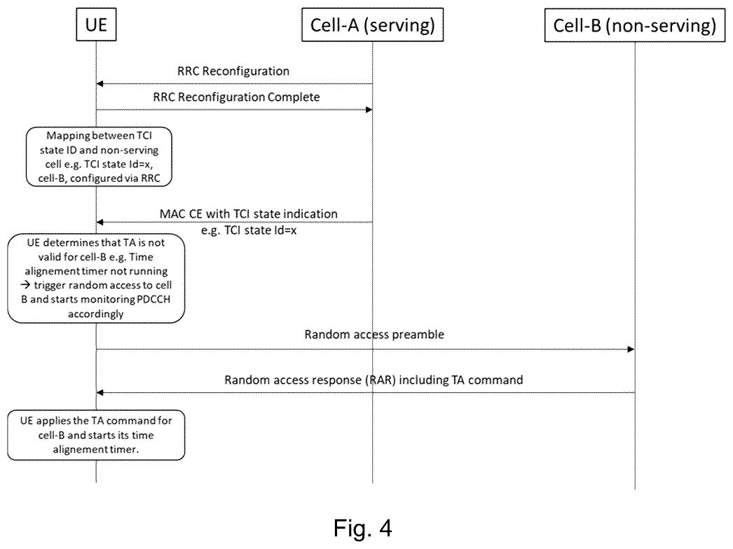

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 3 and 4, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

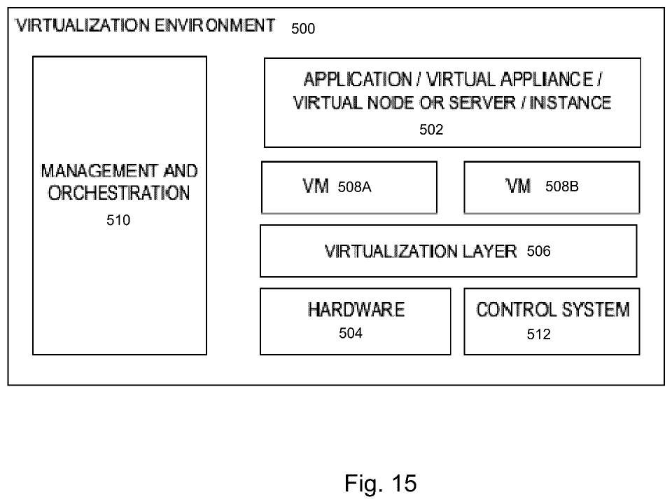

FIG. 15 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

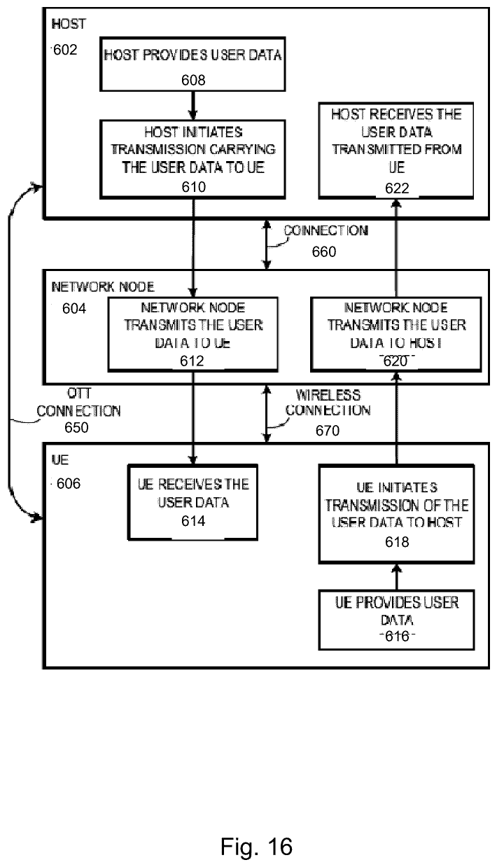

FIG. 16 shows a communication diagram of a host 602 communicating via a network node 604 with a UE 606 over a partially wireless connection in accordance with some embodiments. Example implementations, in accordance with various embodiments, of the UE (such as a UE 112a of FIG. 11 and/or UE 200 of FIG. 12), network node (such as network node 110a of FIG. 11 and/or network node 300 of FIG. 13), and host (such as host 116 of FIG. 11 and/or host 400 of FIG. 14) discussed in the preceding paragraphs will now be described with reference to FIG. 16.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 11) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the delay to directly activate an SCell by RRC and power consumption of user equipment and thereby provide benefits such as reduced user waiting time and extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

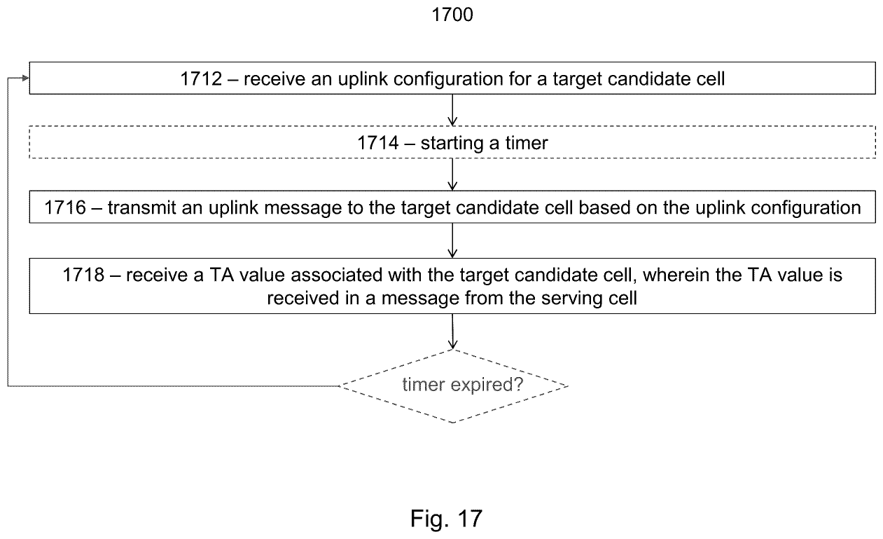

FIG. 17 is a flowchart illustrating an example method in a wireless device, according to certain embodiments. In particular embodiments, one or more steps of FIG. 17 may be performed by UE 200 described with respect to FIG. 12. The wireless device is capable of TA management between the wireless device and at least one target candidate cell for L1/L2 inter-cell mobility. The wireless device is operating in a serving cell different from the target candidate cell.

The method begins at step 1712, where the wireless device (e.g., UE 200) receives an uplink configuration for a target candidate cell. In particular embodiments, the uplink configuration for the target candidate cell is received from a first network node, wherein the first network node corresponds to a serving DU. The uplink configuration for a target candidate cell is generated by a candidate DU associated with the target candidate cell configured for L1/L2 inter-cell mobility.

In particular embodiments, the uplink configuration for the target candidate cell comprises a RACH configuration for the target candidate cell.

In particular embodiments, the uplink configuration includes a trigger condition for sending the uplink message to the target candidate cell. The uplink configuration may be associated with a validity time.

In particular embodiments, the wireless device may receive the uplink configuration according to any of the embodiments and examples described herein.

At step 1714, the wireless device may start a timer. In some embodiments, the wireless device may use the timer do determine when to refresh the TA value.

At step 1716, the wireless device transmits an uplink message to the target candidate cell based on the uplink configuration. In particular embodiments, the uplink message transmitted to the target candidate cell based on the uplink configuration comprises a random access preamble associated to one or more SSBs and CSI-RS resources.

In particular embodiments, the uplink message transmitted to the target candidate cell based on the uplink configuration comprises a SRS.

In particular embodiments, the wireless device may transmit the uplink message according to any of the embodiments and examples described herein.

At step 1718, the wireless device receives a TA value associated with the target candidate cell. The TA value is received in a message from the serving cell.

In particular embodiments, the TA value associated with the target candidate cell received via the serving cell is received in a L1/L2 inter-cell mobility command indicating that the wireless device shall execute L1/L2 inter-cell mobility to the target candidate cell or is received in a RRC Reconfiguration received after the wireless device has been configured with L1/L2 inter-cell mobility and after the UE has transmitted the uplink message to the target candidate cell.

In particular embodiments, the TA value associated with the target candidate cell is received from a first network node, wherein the first network node corresponds to a serving DU.

In particular embodiments, receiving the uplink configuration for the target candidate cell comprises receiving the uplink configuration for the target candidate cell in a first message and transmitting the uplink message to the target candidate cell comprises transmitting the uplink message to the target candidate cell in response to reception of a second message. The first message may comprise a RRC message and the second message comprises a PDCCH order. The second message is received by the wireless device after the wireless device has received the first message.

In some embodiments, the wireless device may need to refresh the TA value. For example, the wireless device may have moved to a new location where the TA value is larger or smaller. The wireless device may perform the refresh based on the timer started at step 1714 or autonomously based on other events or conditions. For example, to refresh in some embodiments the method may return to step 1712 where the wireless device receives an update of the uplink configuration for the target candidate cell; step 1716 where the wireless device transmits an uplink message to the target candidate cell based on the updated uplink configuration; and step 1718 where the wireless device receives a TA value associated with the target candidate cell. The TA value is received in a message from the serving cell.

In particular embodiments, L1/L2 inter-cell mobility comprises receiving signaling indicating a change of serving cell via a signaling layer that is a lower layer than a RRC layer in a protocol stack.

Modifications, additions, or omissions may be made to method 1700 of FIG. 17. Additionally, one or more steps in the method of FIG. 17 may be performed in parallel or in any suitable order.

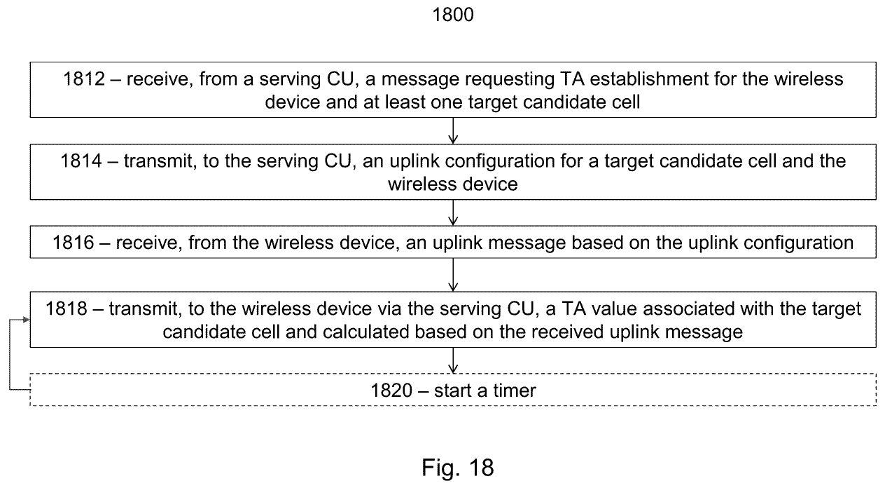

FIG. 18 is a flowchart illustrating an example method in a serving network node, according to certain embodiments. In particular embodiments, one or more steps of FIG. 18 may be performed by network node 300 described with respect to FIG. 13. The network node is capable of operating as a candidate DU for TA management between a wireless device and at least one target candidate cell for L1/L2 inter-cell mobility of the candidate DU.

The method begins at step 1812, where the network node (e.g., network node 300) receives, from a serving CU, a message requesting TA establishment for a wireless device (e.g., UE 200) and at least one target candidate cell. The message requesting TA establishment may comprise any of the messages described with respect to the embodiments and examples described herein.

At step 1814, the network node transmits, to the serving CU, an uplink configuration for a target candidate cell and the wireless device. The uplink configuration is described in more detail with respect to FIG. 17 and the embodiments and examples described above.

At step 1816, the network node receives, from the wireless device, an uplink message based on the uplink configuration. The uplink configuration is described in more detail with respect to the embodiments and examples described above.

At step 1818, the network node transmits, to the wireless device via the serving CU, a TA value associated with the target candidate cell and calculated based on the received uplink message.

In particular embodiments, the method may further continue to step 1820, where the wireless device, in response to transmitting the TA value to the wireless device, starts a timer. In response to expiry of the timer, the method may return to step 1818, where the network node transmits, to the wireless device via the serving CU, a new TA value associated with the target candidate cell.

In particular embodiments, the message requesting TA establishment for the wireless device comprises a request to provide a L1/L2 inter-cell candidate cell configuration.

Modifications, additions, or omissions may be made to method 1800 of FIG. 18. Additionally, one or more steps in the method of FIG. 18 may be performed in parallel or in any suitable order.

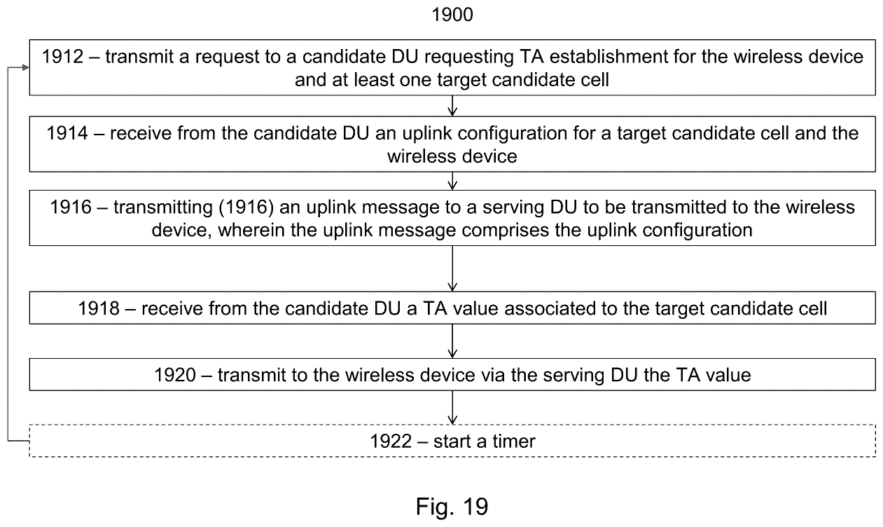

FIG. 19 is a flowchart illustrating an example method in a candidate network node, according to certain embodiments. In particular embodiments, one or more steps of FIG. 19 may be performed by network node 300 described with respect to FIG. 13. The network node is capable of operating as a serving CU for TA management between a wireless device and at least one target candidate cell for L1/L2 inter-cell mobility.

The method begins at step 1912, where the network node (e.g., network node 300) transmits a request to a candidate DU requesting TA establishment for a wireless device (e.g., UE 200) and at least one target candidate cell.

In particular embodiments, the message requesting TA establishment for the wireless device comprises a request to provide a L1/L2 inter-cell candidate cell configuration.

At step 1914, the network node receives from the candidate DU an uplink configuration for a target candidate cell and the wireless device. The uplink configuration is described in more detail with respect to the embodiments and examples described above.

At step 1916, the network node transmits an uplink message to a serving DU to be transmitted to the wireless device. The uplink message comprises the uplink configuration.

At step 1918, the network node receives from the candidate DU a TA value associated to the target candidate cell.

At step 1920, the network node transmits to the wireless device via the serving DU the TA value.

In particular embodiments, the method may continue to step 1922, where the network node, in response to transmitting the TA value to the wireless device, starts a timer. In response to expiry of the timer, the wireless device may return to step 1912, where the network node transmits a request to the candidate DU requesting new TA establishment for the wireless device and at least one target candidate cell.

Modifications, additions, or omissions may be made to method 1900 of FIG. 19. Additionally, one or more steps in the method of FIG. 19 may be performed in parallel or in any suitable order.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

Some example embodiments are described below.

### Group A Embodiments

1. A method performed by a wireless device for timing advance (TA) management between the wireless device and at least one target candidate cell for L1/L2 inter-cell mobility, the method comprising:
   receiving an uplink configuration for a target candidate cell;
   transmitting an uplink message to the target candidate cell based on the uplink configuration; and
   receiving a TA value associated to the target candidate cell, wherein the TA value is received in a message from the serving cell.
2. The method of embodiment 1, wherein the TA value associated to the target candidate cell received via the serving cell is received in a L1/L2 inter-cell mobility command indicating that the wireless device shall execute L1/L2 inter-cell mobility to that target candidate cell.
3. The method of embodiment 1, wherein the TA value associated to the target candidate cell received via the serving cell is received in an RRC Reconfiguration received after the wireless device has been configured with L1/L2 inter-cell mobility and after the UE has transmitted the uplink message to the target candidate cell.
4. The method of embodiment 1, wherein the uplink configuration for a target candidate cell is received from a first network node, wherein the first network node corresponds to a Serving DU.
5. The method of embodiment 1, wherein the uplink configuration for a target candidate cell is generated by a Candidate DU, associated to the target candidate cell configured for L1/L2 inter-cell mobility.
6. The method of embodiment 1, wherein the TA value associated to the target candidate cell is received from a first network node, wherein the first network node corresponds to the Serving DU.
7. The method of embodiment 1, wherein the uplink configuration for a target candidate cell is a Random Access Channel configuration for the target candidate cell.
8. The method of embodiment 1, wherein the uplink message to the target candidate cell based on the UL configuration is a random access preamble, associated to one or more SSBs and/or CSI-RS resources.
9. The method of embodiment 1, wherein the uplink message to the target candidate cell based on the UL configuration is a Sounding Reference Signal (SRS).
10. The method of embodiment 1, further comprising receiving an update of the uplink configuration for the target candidate cell and transmitting an uplink message to the target candidate cell based on the updated uplink configuration and receiving a TA value associated to the target candidate cell, wherein the TA value is received in a message from the serving cell.
11. The method of embodiment 1, wherein the uplink configuration includes a trigger condition for sending the uplink message to the target candidate cell.
12. A method performed by a wireless device for re-establishing/maintaining an existing timing advance (TA) value between the UE and at least one target candidate cell for L1/L2 inter-cell mobility, the method comprising:
   starting a timer when receiving a TA value associated to a target candidate cell;
   Upon the expiry of the timer related to the validity of the TA value: transmitting an UL message to the serving DU for requesting a new TA value related to a target candidate cell, or transmitting an UL message to the target candidate cell based on the UL configuration previously received; and
   Receiving a TA value associated to the target candidate cell, wherein the TA value is received in a message from the serving cell.
13. A method performed by a wireless device, the method comprising:
   any of the wireless device steps, features, or functions described above, either alone or in combination with other steps, features, or functions described above.
14. The method of the previous embodiment, further comprising one or more additional wireless device steps, features or functions described above.
15. The method of any of the previous embodiments, further comprising:
   providing user data; and
   forwarding the user data to a host computer via the transmission to the base station.

### Group B Embodiments

16. A method performed by a base station operating as a Candidate Distributed Unit (Candidate DU) for timing advance (TA) management between a wireless device and at least one target candidate cell for L1/L2 inter-cell mobility of the Candidate DU, the method comprising:
   receiving from a CU a request, requesting the TA establishment for the wireless device and at least one target candidate cell;
   transmitting to the CU an uplink (UL) configuration for a target candidate cell and the wireless device;
   receiving from the wireless device an UL message based on the UL configuration; and
   calculating a TA value associated to the target candidate cell and transmitting that TA value to the CU.
17. A method performed by a base station operating as a Central Unit (CU) for timing advance (TA) management between a wireless device and at least one target candidate cell for L1/L2 inter-cell mobility of the Candidate DU, the method comprising:
   transmitting a request to a Candidate DU, requesting the TA establishment for the wireless device and at least one target candidate cell;
   receiving from the Candidate DU an UL configuration for a target candidate cell and the wireless device;
   transmitting an UL message to the Serving DU to be transmitted to the wireless device, wherein the UL message comprises the UL configuration;
   receiving from the Candidate DU a TA value associated to the target candidate cell; and
   transmitting to the Serving DU the TA value.
18. A method performed by a base station, the method comprising:
   any of the steps, features, or functions described above with respect to base station, either alone or in combination with other steps, features, or functions described above.
19. The method of the previous embodiment, further comprising one or more additional base station steps, features or functions described above.
20. The method of any of the previous embodiments, further comprising:
   obtaining user data; and
   forwarding the user data to a host computer or a wireless device.

### Group C Embodiments

21. A mobile terminal comprising:
   processing circuitry configured to perform any of the steps of any of the Group A embodiments; and
   power supply circuitry configured to supply power to the wireless device.
22. A base station comprising:
   processing circuitry configured to perform any of the steps of any of the Group B embodiments;
   power supply circuitry configured to supply power to the wireless device.
23. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
24. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
25. The communication system of the pervious embodiment further including the base station.
26. The communication system of the previous 2 embodiments, further including the UE, wherein the UE is configured to communicate with the base station.
27. The communication system of the previous 3 embodiments, wherein:
   the processing circuitry of the host computer is configured to execute a host application, thereby providing the user data; and
   the UE comprises processing circuitry configured to execute a client application associated with the host application.
28. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
29. The method of the previous embodiment, further comprising, at the base station, transmitting the user data.
30. The method of the previous 2 embodiments, wherein the user data is provided at the host computer by executing a host application, the method further comprising, at the UE, executing a client application associated with the host application.
31. A user equipment (UE) configured to communicate with a base station, the UE comprising a radio interface and processing circuitry configured to performs any of the previous 3 embodiments.
32. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
33. The communication system of the previous embodiment, wherein the cellular network further includes a base station configured to communicate with the UE.
34. The communication system of the previous 2 embodiments, wherein:
   the processing circuitry of the host computer is configured to execute a host application, thereby providing the user data; and
   the UE's processing circuitry is configured to execute a client application associated with the host application.
35. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
36. The method of the previous embodiment, further comprising at the UE, receiving the user data from the base station.
37. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
38. The communication system of the previous embodiment, further including the UE.
39. The communication system of the previous 2 embodiments, further including the base station, wherein the base station comprises a radio interface configured to communicate with the UE and a communication interface configured to forward to the host computer the user data carried by a transmission from the UE to the base station.
40. The communication system of the previous 3 embodiments, wherein:
   the processing circuitry of the host computer is configured to execute a host application; and
   the UE's processing circuitry is configured to execute a client application associated with the host application, thereby providing the user data.
41. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
42. A method implemented in a communication system including a host computer, a base station and a user equipment (UE), the method comprising:
   at the host computer, receiving user data transmitted to the base station from the UE, wherein the UE performs any of the steps of any of the Group A embodiments.
43. The method of the previous embodiment, further comprising, at the UE, providing the user data to the base station.
44. The method of the previous 2 embodiments, further comprising:
   at the UE, executing a client application, thereby providing the user data to be transmitted; and
   at the host computer, executing a host application associated with the client application.
45. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
46. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
47. The communication system of the previous embodiment further including the base station.
48. The communication system of the previous 2 embodiments, further including the UE, wherein the UE is configured to communicate with the base station.
49. The communication system of the previous 3 embodiments, wherein:
   the processing circuitry of the host computer is configured to execute a host application;
   the UE is configured to execute a client application associated with the host application, thereby providing the user data to be received by the host computer.
50. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
51. The method of the previous embodiment, further comprising at the base station, receiving the user data from the UE.
52. The method of the previous 2 embodiments, further comprising at the base station, initiating a transmission of the received user data to the host computer.

1.-46. (canceled)

47. A method performed by a wireless device for timing advance (TA) management between the wireless device and at least one target candidate cell for layer one (L1)/layer two (L2) inter-cell mobility, wherein the wireless device is operating in a serving cell different from the target candidate cell, the method comprising:
receiving an uplink configuration for a target candidate cell;
transmitting an uplink message to the target candidate cell based on the uplink configuration; and
receiving a TA value associated with the target candidate cell, wherein the TA value is received in a message from the serving cell.

48. The method of claim 47, wherein the TA value associated with the target candidate cell received via the serving cell is received in a L1/L2 inter-cell mobility command indicating that the wireless device shall execute L1/L2 inter-cell mobility to the target candidate cell.

49. The method of claim 47, wherein the uplink configuration for the target candidate cell comprises a random access channel (RACH) configuration for the target candidate cell.

50. The method of claim 47, wherein the uplink message transmitted to the target candidate cell based on the uplink configuration comprises a random access preamble associated to one or more synchronization signal blocks (SSBs) and channel state information reference signal (CSI-RS) resources.

51. The method of claim 47, wherein the uplink message transmitted to the target candidate cell based on the uplink configuration comprises a sounding reference signal (SRS).

52. The method of claim 47, wherein the uplink configuration includes a trigger condition for sending the uplink message to the target candidate cell.

53. The method of claim 47, wherein the uplink configuration is associated with a validity time.

54. The method of claim 47, wherein:
receiving the uplink configuration for the target candidate cell comprises receiving the uplink configuration for the target candidate cell in a first message; and
transmitting the uplink message to the target candidate cell comprises transmitting the uplink message to the target candidate cell in response to reception of a second message.

55. The method of claim 54, wherein the first message comprises a Radio Resource Control (RRC) message and the second message comprises a physical downlink control channel (PDCCH) order and wherein the second message is received by the wireless device after the wireless device has received the first message.

56. The method of claim 47, further comprising:
receiving an update of the uplink configuration for the target candidate cell;
transmitting an uplink message to the target candidate cell based on the updated uplink configuration; and
receiving a TA value associated with the target candidate cell, wherein the TA value is received in a message from the serving cell.

57. The method of claim 47, further comprising:
in response to receiving the uplink configuration for the target candidate cell, starting a timer;
in response to expiry of the timer, transmitting an uplink message to the target candidate cell; and
receiving a TA value associated with the target candidate cell, wherein the TA value is received in a message from the serving cell.

58. A wireless device operable to perform timing advance (TA) management between the wireless device and at least one target candidate cell for layer one (L1)/layer two (L2) inter-cell mobility when the wireless device is operating in a serving cell different from the target candidate cell, the wireless receiver comprising processing circuitry operable to:
receive an uplink configuration for a target candidate cell;
transmit an uplink message to the target candidate cell based on the uplink configuration; and
receive a TA value associated with the target candidate cell, wherein the TA value is received in a message from the serving cell.

59. A method performed by a network node operating as a candidate distributed unit (DU) for timing advance (TA) management between a wireless device and at least one target candidate cell for layer one (L1)/layer two (L2) inter-cell mobility of the candidate DU, the method comprising:
receiving, from a serving central unit (CU), a message requesting TA establishment for the wireless device and at least one target candidate cell;
transmitting, to the serving CU, an uplink configuration for a target candidate cell and the wireless device;
receiving, from the wireless device, an uplink message based on the uplink configuration; and
transmitting, to the wireless device via the serving CU, a TA value associated with the target candidate cell and calculated based on the received uplink message.

60. The method of claim 59, wherein the message requesting TA establishment for the wireless device comprises a request to provide a L1/L2 inter-cell candidate cell configuration.

61. The method of claim 59, further comprising:
in response to transmitting the TA value to the wireless device, starting a timer; and
in response to expiry of the timer, transmitting, to the wireless device via the serving CU, a new TA value associated with the target candidate cell.

62. A network node capable of operating as a candidate distributed unit (DU) for timing advance (TA) management between a wireless device and at least one target candidate cell for layer one (L1)/layer two (L2) inter-cell mobility of the candidate DU, the network node comprising processing circuitry operable to:
receive, from a serving central unit (CU), a message requesting TA establishment for the wireless device and at least one target candidate cell;
transmit, to the serving CU, an uplink configuration for a target candidate cell and the wireless device;
receive, from the wireless device, an uplink message based on the uplink configuration; and
transmit, to the wireless device via the serving CU, a TA value associated with the target candidate cell and calculated based on the received uplink message.

63. A method performed by a network node operating as a serving central unit (CU) for timing advance (TA) management between a wireless device and at least one target candidate cell for layer one (L1)/layer two (L2) inter-cell mobility, the method comprising:
transmitting a request to a candidate distributed unit (DU) requesting TA establishment for the wireless device and at least one target candidate cell;
receiving from the candidate DU an uplink configuration for a target candidate cell and the wireless device;
transmitting an uplink message to a serving DU to be transmitted to the wireless device, wherein the uplink message comprises the uplink configuration;
receiving from the candidate DU a TA value associated to the target candidate cell; and
transmitting to the wireless device via the serving DU the TA value.

64. The method of claim 63, wherein the message requesting TA establishment for the wireless device comprises a request to provide a L1/L2 inter-cell candidate cell configuration.

65. The method of claim 63, further comprising:
in response to transmitting the TA value to the wireless device, starting a timer; and
in response to expiry of the timer, transmitting a request to the candidate DU requesting new TA establishment for the wireless device and at least one target candidate cell.

66. A network node capable of operating as a serving central unit (CU) for timing advance (TA) management between a wireless device and at least one target candidate cell for layer one (L1)/layer two (L2) inter-cell mobility, the network node comprising processing circuitry operable to:
transmit a request to a candidate distributed unit (DU) requesting TA establishment for the wireless device and at least one target candidate cell;
receive from the candidate DU an uplink configuration for a target candidate cell and the wireless device;
transmit an uplink message to a serving DU to be transmitted to the wireless device, wherein the uplink message comprises the uplink configuration;
receive from the candidate DU a TA value associated to the target candidate cell; and
transmit to the wireless device via the serving DU the TA value.
